(19) United States
(12) Patent Application Publication
(10) Pub. No.: US 2025/0194739 A1
(43) Pub. Date: Jun. 19, 2025

(54) SOLE PLATE FOR AN ARTICLE OF FOOTWEAR

(71) Applicant: adidas AG, Herzogenaurach (DE)

(72) Inventors: Korbinian LEHNER, Hausen (DE); Jochen BARTL, Langensendelbach (DE); Falk BRUNS, Nuremberg (DE); Sam TRUAX, Nuremberg (DE); Herisson REDI, Nuremberg (DE); Florence ROHART, Nuremberg (DE)

(21) Appl. No.: 18/978,935

(22) Filed: Dec. 12, 2024

(30) Foreign Application Priority Data
Dec. 15, 2023 (DE) 10 2023 135 410.8

(51) Int. Cl. A43B 13/14; B29C 45/16; B29K 75/00; B29K 77/00; B29K 307/04; B29L 31/50

(52) U.S. Cl. CPC A43B 13/14; B29C 45/164; B29C 45/1676; B29K 2075/00; B29K 2077/00; B29K 2307/04; B29K 2995/007; B29L 2031/504

(57) ABSTRACT

The present disclosure relates to a sole plate for an article of footwear, in particular for a sports shoe such as a running shoe, the sole plate comprising: a first portion comprising a first material; and a second portion comprising a second material; wherein the second material has a greater stiffness than the first material; and wherein, when the sole plate is for a right shoe, the first portion is arranged on a medial side of the sole plate and the second portion is arranged on a lateral side of the sole plate, and/or wherein, when the sole plate is for a left shoe, the first portion is arranged is arranged on a lateral side of the sole plate and the second portion is arranged on a medial side of the sole plate, wherein the sole plate comprises one or more first apertures.

### CROSS REFERENCE TO RELATED APPLICATION

This application claims priority to German Patent Application No. 10 2023 135 410.8, filed Dec. 15, 2023, which is incorporated by reference herein in its entirety.

### TECHNICAL FIELD

The present disclosure relates to a sole plate for an article of footwear, in particular for a sports shoe such as a running shoe. The sole plate can comprise a first portion comprising a first material and a second portion comprising a second material, wherein the second material can have a greater stiffness than the first material.

The present disclosure also relates to a method for manufacturing one or more sole plates for one or more articles of footwear, a sole manufactured by said method, an article of footwear in particular a sports shoe, an apparatus for manufacturing one or more sole plates, and a pair of shoes comprising a right shoe and a left shoe.

### BACKGROUND

Articles of footwear and sole plates for such articles are generally known and have various purposes and use cases. For instance, they may be designed to provide benefits for sport applications, for daily work, for leisure time or the like. Particularly in sport applications, sole plates for shoes have the potential to provide beneficial performance characteristics such that the overall performance of the wearer during an athletic activity can be increased.

An article of footwear can be described as the combination of an upper and a sole. Typically, the upper covers regions such as the instep, the toe, the medial side, the lateral side, and the heel of a wearer's foot, and provides an opening to allow the wearer to step inside the footwear. The sole is connected to the upper such that the sole's top side faces an underfoot portion of the upper, and its bottom side touches the ground during ordinary use of the shoe.

In articles of footwear, the sole can comprise a midsole and an outsole. The midsole can be made of a foam material or a resiliently deformable foam material. The midsole can be interposed between the insole and the outsole and can provide for sufficient cushioning and energy return to the wearer. The outsole can provide for ground contact and is often made of a durable and wear-resistance material. In some cases, an outsole can be provided to improve traction to the ground. For instance, outsole can be provided with one or more cleats, studs, spikes, or the like. Spikes can be important for running shoes that are used for track and field events.

Particularly in relation to running shoes for track events, such articles of footwear can have specific requirements to facilitate performing athletic activities. Requirements that can be of importance to such an article of footwear is that the shoe should improve running performance. This can be important when an athlete is running on curved tracks, which is often the case in track and field events.

Against this background, it is an object of the present disclosure to provide an improved sole plate for an article of footwear. The wearer of the article of footwear should be able to perform athletic activities in an improved manner, particularly when the sole plate is used for running in track and field events. It is a further object of the present disclosure to provide a method and a respective apparatus for manufacturing a sole plate.

### BRIEF SUMMARY

The present disclosure is directed to a sole plate for an article of footwear and methods for manufacturing the sole plate. The sole plate can comprise a first portion having a first material and a second portion having a second material, where the second material has a greater stiffness than the first material. The first material and the second material can be arranged on the article of footwear to provide support to the foot of the wearer based on the activity the wearer performs. For example, when the article of footwear is a running shoe and the wearer is running on a curved track, the first material and the second material can be arranged to support the foot of the wearer based on an asymmetrical force imparted to the running shoe by the curvature of the track. In this manner, the methods according to present disclosure provide improved sole plates that can provide for cushioning and support in desired areas.

A first embodiment (I) of the present disclosure is directed to a sole plate for an article of footwear, in particular for a sports shoe such as a running shoe, the sole plate comprising: a first portion comprising a first material; and a second portion comprising a second material; wherein the second material has a greater stiffness than the first material; and wherein, when the sole plate is for a right shoe, the first portion is arranged on a medial side of the sole plate and the second portion is arranged on a lateral side of the sole plate, and/or wherein, when the sole plate is for a left shoe, the first portion is arranged is arranged on a lateral side of the sole plate and the second portion is arranged on a medial side of the sole plate, wherein the sole plate comprises one or more first apertures.

In a second embodiment (II), in the method of the first embodiment (I), the second material has a stiffness compared to the first material of at least 1.1 times greater than the stiffness of the first material, at least 1.2 times greater than the stiffness of the first material, at least 1.5 times greater than the stiffness of the first material, at least 2.0 times greater than the stiffness of the first material, at least 3.0 times greater than the stiffness of the first material, at least 4.0 times greater than the stiffness of the first material, at least 5.0 times greater than the stiffness of the first material, or at least 6.0 times greater than the stiffness of the first material.

In a third embodiment (III), in the method of the any one of embodiments (I)-(II), the second material has a greater hardness compared to the first material.

In a fourth embodiment (IV), in the method of the third embodiment (III), the first material has a shore D hardness of at most 70 shore D, at most 65 shore D, or at most 60 shore D, and/or wherein the second material has a shore D hardness of at least 65 shore D, at least 70 shore D, or at least 72 shore D.

In a fifth embodiment (V), in the method any one of embodiments (I-IV), the second material has a greater flexural modulus compared to the first material.

In a sixth embodiment (VI), in the method of the fifth embodiment (V), the first material has a flexural modulus of at most 1000 MPa, at most 800 MPa, at most 600 MPa, at most 400 MPa, at most 300 MPa, or at most 250 MPa, and/or wherein the second material has a flexural modulus of at least 800 MPa, at least 1000 MPa, at least 1200 MPa, at least 1300 MPa, at least 1400 MPa, or at least 1500 MPa.

In a seventh embodiment (VII), in the method of any one of embodiments (I)-(VI), the one or more first apertures have an elongated shape, such as a shape of a slit, a groove, a cut, or a vent.

In an eighth embodiment (VIII), in the method of any one of embodiments (I)-(VII), the one or more first apertures define through holes.

In a ninth embodiment (IX), in the method of any one of embodiments (I)-(VIII), the one or more first apertures extend in a longitudinal direction of the sole plate and in a transverse direction of the sole plate, wherein the extension in the longitudinal direction is larger compared to the extension in the transverse direction.

In a tenth embodiment (X), in the method of any one of embodiments (I)-(IX), the one or more first apertures are arranged in the first portion of the sole plate.

In an eleventh embodiment (XI), in the method of any one of embodiments (I)-(X), the sole plate comprises one or more second apertures arranged in the second portion of the sole plate.

In a twelfth embodiment (XII), in the method of any one of embodiments (I)-(XI), a number of the one or more first apertures is greater than a number of the one or more second apertures.

In a thirteenth embodiment (XIII), in the method of any one of embodiments (I)-(XII), one or more spikes are arranged on a forefoot portion of the sole plate, wherein the sole plate comprises one or more receptacles, wherein the one or more receptacles are arranged on the forefoot portion of the sole plate, wherein the one or more receptacles are configured to receive the one or more spikes.

In a fourteenth embodiment (XIV), in the method of the eleventh embodiment (XI), the one or more first apertures and/or the one or more second apertures have a length (L) in a longitudinal direction of the sole plate of at least 1 cm, at least 2 cm, at least 4 cm, at least 6 cm, at least 7 cm, at least 8 cm, at least 10 cm, at least 12 cm, at least 14 cm, or at least 15 cm, and/or wherein the one or more first apertures and/or the one or more second apertures have a length (L) in a longitudinal direction of the sole plate of at most 25 cm, at most 23 cm, at most 20 cm, at most 18 cm, at most 16 cm, or at most 15 cm.

In a fifteenth embodiment (XV), in the method of any one of embodiments (I)-(XIV), the sole plate comprises a maximum thickness of at most 10 mm, at most 8 mm, at most 6 mm, at most 5 mm, at most 4 mm, or at most 3 mm.

In a sixteenth embodiment (XVI), in the method of any one of embodiments (I)-(XV), the sole plate comprises an integrally formed piece extending from a heel region of the sole plate to a toe region of the sole plate.

A seventeenth embodiment (XVII) of the present disclosure is directed to a method for manufacturing one or more sole plates for one or more articles of footwear, comprising: providing a mold; injecting a first material into the mold; and injecting a second material into the mold; wherein injecting the first material and injecting the second material takes place at least partially at the same time.

In an eighteenth embodiment (XVIII), in the method of the seventeenth embodiment (XVII), the first material is different than the second material.

In a nineteenth embodiment (XIX), in the method of any one of embodiments (XVII)-(XVIII), the second material has a greater stiffness compared to the first material.

In a twentieth embodiment (XX), in the method of any one of embodiments (XVII)-(XIX), the method comprising forming a first sole plate and a second sole plate at the same time.

In a twenty-first embodiment (XXI), in the method of the twentieth amendment (XX), the first sole plate is a sole plate for a right shoe and the second sole plate is a sole plate for a left shoe.

In a twenty-second embodiment (XXII), in the method of any one of embodiments (XX)-(XXI), the first sole plate comprises a first portion arranged on a medial side of the first sole plate and a second portion arranged on a lateral side of the first sole plate; wherein the second sole plate comprises a first portion arranged on a lateral side of the second sole plate and a second portion arranged on a medial side of the second sole plate; wherein injecting the first material comprises injecting the first material in the first portion of the first sole plate and in the first portion of the second sole plate; and wherein injecting the second material comprises injecting the second material in the second portion of the first sole plate and in the second portion of the second sole plate.

In a twenty-third embodiment (XXIII), in the method of any one of embodiments (XX)-(XXII), the first sole plate and the second sole plate form an asymmetric pair of sole plates.

In a twenty-fourth embodiment (XXIV), in the method of any one of embodiments (XVII)-(XXIII), injecting the second material comprises using more injection nozzles compared to injecting the first material.

In a twenty-fifth embodiment (XXV), a sole plate for an article of footwear is manufactured according to the method of any one of embodiments (XVII)-(XXIV).

In a twenty-sixth embodiment (XXVI), an apparatus for manufacturing one or more sole plates comprises means for performing the method of any one of embodiments (XVII)-(XXIV).

In a twenty-seventh embodiment (XXVII), in the method of any one of embodiments (I)-(XXIV), the first material comprises one or more of the following: polyamide, PA, polyurethane, PU, thermoplastic polyurethane, TPU, and/or wherein the second material comprises one or more of the following: polyamide, PA, fiber-reinforced PA, or carbon fiber-reinforced PA, wherein the carbon content by weight is at least 1%, at least 2%, at least 4%, or at least 6%.

In a twenty-eighth embodiment (XXVIII), an article of footwear comprises: the sole plate of any one of embodiments (I)-(XVI); and an upper; wherein the sole plate is attached to the upper.

In a twenty-ninth embodiment (XXIX), the article of footwear of the twenty-eighth embodiment (XXVIII), wherein the article of footwear is a running shoe used for track and field running.

In a thirtieth embodiment (XXX), a pair of shoes comprises a right shoe and a left shoe, wherein the right shoe comprises a first sole plate of any one of embodiments (I)-(XVI); and wherein the left shoe comprises a second sole plate of any one of embodiments (I)-(XVI).

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 shows a first sole plate and a second sole plate, each respectively for an article of footwear, according to some embodiments.

FIG. 2 shows a detailed view of FIG. 1, according to some embodiments.

FIG. 2a shows a detailed view of FIG. 1, according to some embodiments.

FIG. 3 shows a first sole plate and a second sole plate, each respectively for an article of footwear, during manufacturing thereof, according to some embodiments.

FIG. 4 shows a flow chart of a method for manufacturing one or more sole plates, according to some embodiments.

FIG. 5 shows a second sole plate for an article of footwear, according to some embodiments.

### DETAILED DESCRIPTION

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

The term “heel portion” and/or “heel region” of a sole plate as used herein can refer to the back part of the sole plate, (for example, the rear part of the sole plate), which can be in proximity to the heel of the foot of the wearer, when worn during use. In the heel portion and/or heel region of the sole plate, a posterior end of a foot of the wearer can be received. In particular, the “calcaneal region” of a foot of a wearer may be received. The calcaneus is a large bone that makes up the heel of the foot.

The term “toe portion” and/or “toe region” of a sole plate as used herein can refer to the front part of the sole plate, (for example, the forefoot part of the sole plate), in which toes of the foot of the wearer can be received, when worn during use. The toes of the foot of the wearer can comprise the big toe, and/or of the big toe knuckle. The toe portion and/or the toe region can comprise an anterior end of the foot, when worn. Further, the toe portion and/or the toe region can comprise distal phalanges, intermedial phalanges and proximal phalanges of a foot of a wearer, when worn. The toe portion and/or the toe region can comprise a frontal part of the metatarsal bones of a foot of a wearer, when worn.

The term “medial,” “medial side,” “medial side region,” and/or “medial side portion” of a sole plate as used herein can refer to an inner side of the sole plate. This inner side can be closer to a centerline of the body of the wearer, when the shoe comprising the sole is worn, as compared to a lateral side. This inner side can extend from a toe region to a heel region. The inner side can comprise substantially about half of the part of the sole plate that is arranged medially as seen from a heel to toe midline of the sole plate. The heel to toe midline can extend along the heel to toe axis of the sole plate.

The term “lateral,” “lateral side,” “lateral side region,” and/or “lateral side portion” of a sole plate as used herein can refer to an outer side of the sole plate. This outer side can be farther away from a centerline of the body of the wearer, when the shoe comprising the sole is worn, as compared to a medial side. The outer side can extend from a toe region to a heel region. The outer side can comprise substantially about half of the part of the sole plate that is arranged laterally as seen from a heel to toe midline. The heel to toe midline can extend along the heel to toe axis of the sole plate.

The term “vertical axis” as used herein can substantially correspond to the wearer's main body axis from head to foot when the wearer stands on the ground.

The term “aperture” as used herein can be understood as an opening or the like.

The term “wearer” as used herein can be any kind of human capable of wearing an article of footwear. The term “wearer” can be used synonymously to the terms “user,” “athlete,” “human being,” “person,” or the like.

The term “hardness” as used herein can be understood as the ability of a material to withstand force without deformation, scratching, penetration, and/or indentation. In other words, the hardness can be the ability of a material to substantially maintain its physical features even in the face of applied force.

The term “flexural modulus” as used herein can be understood as a bending modulus. The flexural modulus can be an intensive property that is determined as the ratio of stress to strain in flexural deformation, and/or the tendency for a material to resist bending.

The term “elongated” as used herein (e.g., as used when a shape of an aperture is elongated) means that there can be a dimension along one axis of the aperture which can be larger than one or both dimensions along the remaining axes, the remaining axes being substantially perpendicular to the one axis. It can be understood that when dimensions are described herein, manufacturing tolerances can be taken into consideration. Thus, the dimensions described herein can vary slightly. The term elongated as used to describe a shape can additionally or alternatively mean that said shape is slender or the like.

The term “athletic activity,” and/or “athletic activities” as used herein can comprise one or more and/or any combination of at least the following non-exhaustive list of activities: aerobics, athletic exercises, running, hiking, climbing, group fitness classes, walking, cycling, yoga, soccer, tennis, football, basketball, doing a workout, volleyball, gymnastics, weightlifting, cross-training, baseball, softball, rugby, field hockey, wrestling, squash, track and field (such as sprinting, long jump, high jump), or cross-country skiing.

Unless otherwise stated, the term “substantial” or “substantially” as used herein can be understood to a great or significant extent or for the most part or essentially. Manufacturing tolerances can be included by this term. Hence, any values or arrangements described by using the term “substantial” or “substantially” can slightly deviate from the described values or arrangements.

As used herein, reference to objects or axes being “substantially parallel” to each other includes parallel and relationships between the objects or axes up to and including within ten degrees of being parallel. For example, two axes that are oriented at an angle of negative 10 degrees to positive 10 degrees relative to each other are considered substantially parallel.

As used herein, reference to objects or axes being “substantially perpendicular” to each other includes perpendicular and relationships between the objects or axes up to and including within 10 degrees of being perpendicular. For example, two axes that are oriented at an angle of 80-100 degrees relative to each other are considered substantially perpendicular.

The term “and/or” is only an association relationship describing associated objects and represents that three relationships can exist. For example, A and/or B can represent three conditions: for example, independent existence of A, existence of both A and B and independent existence of B. In addition, the character “/” in the disclosure represents that previous and next associated objects form an “or” relationship.

The terms “bottom,” “top,” “one end,” “the other end,” “outer side,” “upper,” “above,” “inner side,” “under,” “below,” “horizontal,” “coaxial,” “central,” “end,” “part,” “length,” “outer end,” etc., which indicate the orientation or positional relationship, are based on the orientation or positional relationship shown in the drawings.

The terms “upper,” “above,” “below,” “under,” and the like can be used in the present disclosure to indicate a relative position in space for the purpose of facilitating explanation to describe a sole plate, an article of footwear, an element, a part, an object and/or a feature shown in the drawings relative to the relationship of another article of footwear, element, part, object and/or feature.

In the following, only some possible embodiments of the disclosure are described in detail. However, the present disclosure is not limited to these, and a multitude of other embodiments are applicable without departing from the scope of the disclosure. The presented embodiments can be modified in a number of ways and combined with each other whenever compatible and certain features can be omitted in so far as they appear dispensable. In particular, the disclosed embodiments can be modified by combining certain features of one embodiment with one or more features of another embodiment.

It is to be understood that not all features of the described embodiments have to be present for realizing the technical advantages provided by the present disclosure, which is defined by the subject-matter of the claims. The disclosed embodiments can be modified by combining certain features of one embodiment with one or more features of another embodiment. Specifically, the skilled person will understand that features, and/or functional elements of one embodiment can be combined with technically compatible features, and/or functional elements of any other embodiment of the present disclosure given that the resulting combination falls within the definition of the present disclosure.

While the embodiments below are described primarily with reference to a sole plate for an article of footwear, in particular a sports shoe, the skilled person will recognize that the disclosure according to the disclosure can equally be applied in a plurality of different technical fields and/or use cases.

Throughout the present figures and specification, the same reference numerals refer to the same elements. For the sake of clarity and conciseness, certain features, parts, elements, aspects, components and/or steps of certain embodiments are presented without undue detail where such detail would be apparent to the skilled person in the art in light of the teachings herein and/or where such detail would obfuscate an understanding of more pertinent aspects of the embodiments.

As understood by the skilled person and/or in order to avoid redundancies, reference is also made to the explanations in the preceding sections, which also apply to the following detailed description. Further, not all features, parts, elements, aspects, components and/or steps are expressly indicated by reference signs for the sake of brevity and clarity. This particularly applies, where the skilled person recognizes that such features, parts, elements, aspects, components and/or steps are present in a plurality.

The above-mentioned objects are at least partially achieved by the subject-matter of the claims and through the overall disclosure of the present application. It is noted that the headlines in the present disclosure are provided solely for the purpose to assist in keeping an overview during reading. The headlines do not mean that features of the respective embodiments cannot be combined.

### Sole Plate for an Article of Footwear

In some embodiments, the objects of the present disclosure are at least partially solved by a sole plate for an article of footwear, such as a running shoe, the sole plate comprising: a first portion comprising a first material; and a second portion comprising a second material; wherein the second material can have a greater stiffness than the first material; and wherein, when the sole plate is for a right shoe, the first portion can be arranged on a medial side of the sole plate and the second portion can be arranged on a lateral side of the sole plate, and/or wherein, when the sole plate is for a left shoe, the first portion can be arranged on a lateral side of the sole plate and the second portion can be arranged on a medial side of the sole plate, wherein the sole plate can comprise one or more first apertures.

Embodiments of the sole plate for an article of footwear described herein can facilitate improved support to a wearer, such as when it is used for a shoe during running such as running on an athletics track. In some embodiments, an optimized behavior for track and field runners can be achieved, as they typically run a curve (which can be understood as a bend) on an athletics track. Alternatively or additionally, an optimized behavior can be achieved for high-jump or any other sports discipline in track and field sport events. It can be appreciated that when the sole plate can be a sole plate for a right shoe and/or a sole plate for a left shoe, the arrangement of the first portion of the sole plate and the second portion of the sole plate can be adjusted accordingly. Thereby, different sole plates for a left shoe and a right shoe can be provided, which can be useful when running a curve. The left shoe and the right shoe can thereby differ in material properties, which can be useful for sufficient support and/or cushioning. In addition, the left shoe and the right shoe can thereby differ in geometry. For instance, they can be asymmetrical. In this manner, the sole plate can provide for tailored shoes for a left foot and a right foot of the wearer.

As mentioned above, the sole plate can be useful for track and field runners. In some instances, track and field runners can run in a counterclockwise direction of the track. This can apply for instance during a competition and/or during usual training or the like. Thereby, the runners tend to lean inwards toward their left sides. Thus, the left shoe and the right shoe can be exposed to different load conditions compared to running on a substantially straight line. In addition, the load distribution within one shoe alone and, thereby, of one sole plate alone can differ. Adjustments to the sole plate can be made to account for these differences. Embodiments of the sole plate described herein can address these needs by providing a stiffer material on a lateral side of the sole plate when used for a right shoe, and a stiffer material on a medial side of the sole plate when used for a left shoe. Further, a less stiff (for example, softer) material can be provided on the medial side of the sole plate when used for a right shoe and a less stiff material can be provided on the lateral side of the sole plate when used for a left shoe. This can have the advantage that a less stiff material can be provided on the side of the sole plate which can come into contact with the ground first.

The one or more first apertures can have the advantage of contributing to an improved performance of the sole plate. For example, the behavior under a load impact can be improved because expansion of the first material and/or the second material into the one or more first apertures can be facilitated. In some embodiments, the one or more first apertures can allow the first material and/or the second material to expand substantially horizontally. Any other direction of expansion and/or combinations of other directions of expansion can be provided by embodiments disclosed herein. This can improve the cushioning effect, which can be appreciated by the wearer. In some embodiments, the cushioning effect can be improved without substantially impacting stability and durability of the sole plate, due to a tailored design of the one or more first apertures. The one or more first apertures can provide the advantage of reducing the weight of the sole plate, thereby reducing the overall weight of a shoe comprising the sole plate. A lightweight shoe can be advantageous when it is used for an athletic activity like running. The one or more first apertures can also allow for a different layer of a shoe to expand into the one or more first apertures. For example, an insole can at least partially expand into the one or more first apertures. Alternatively or additionally, a midsole foam material can partially expand into the one or more first apertures. As shoes for track and field events can be stiff, such an expansion can be appreciated by the wearer and can contribute to reduced fatigue.

In some embodiments, the one or more first apertures can reduce a stiffness of portions of the sole plate where the one or more first apertures are located. For example, the one or more first apertures can provide lateral flexibility while keeping stiffness in a lengthwise direction of the sole plate. This can be appreciated by the wearer during an athletic activity.

In some embodiments, the first portion of the sole plate and/or the second portion of the sole plate can have any dimension. In particular, they can have any dimension along the heel to toe axis and/or the medial to lateral axis. Further, they can have any dimension along a vertical axis, (for example, in a direction of the depth of the sole plate). In some embodiments, the first portion and/or the second portion can extend strategically to certain portions of the sole plate to suit specific needs of the athletic activity.

The medial side of the sole plate can cover about half of the part of the sole plate that is arranged medially as seen from a heel to toe midline of the sole plate. The heel to toe midline of the sole plate can extend along the heel to toe axis of the sole plate. The lateral side of the sole plate can cover about half of the part of the sole plate that is arranged laterally as seen from the heel to toe midline. The “half of the part” of the sole plate can in some cases slightly vary, as the sole plate can be asymmetric. This variation is expressed by the term “about.”

The one or more first apertures of the sole plate can be implemented in various ways, including but not limited to recesses, grooves, slots, slits, cutouts, or the like as described elsewhere herein in greater detail. In some embodiments, the one or more first apertures of the sole plate can be through-holes. This can further contribute to an enhanced expansion effect of the sole plate in general and/or of the first material and/or the second material that is comprised by the first portion and/or the second portion, respectively. In some embodiments, the one or more first apertures can be understood as an opening, whose size can be adjustable. This could have further benefits regarding adapted cushioning.

The one or more first apertures of the sole plate can have a closed boundary. The closed boundary can be understood such that the one or more first apertures of the sole plate can be enclosed by a periphery of the sole plate. In other words, the one or more first apertures of the sole plate can be within the sole plate. The one or more first apertures of the sole plate can be shaped such that light could pass through.

It is noted that the term “first” of the expression “one or more first apertures” does not limit the term “apertures” itself. In particular, this does not mean that a “first aperture” must be different than a “second aperture” and/or that a “first aperture” is more limiting than an “aperture” alone. The term “first” is merely used to name the aperture. For example, the same features and advantages described with reference to the “one or more first apertures” can be equally applicable to the “one or more second apertures.” This is also described elsewhere herein.

It can be understood that the advantages of the sole plate for an article of footwear as described in the foregoing can apply also for the following embodiments.

### Properties of the Sole Plate

In some embodiments of the sole plate for an article of footwear as described herein, the second material can have a stiffness compared to the first material of at least 1.1 times greater than the stiffness of the first material, at least 1.2 times greater than the stiffness of the first material, at least 1.5 times greater than the stiffness of the first material, at least 2.0 times greater than the stiffness of the first material, at least 2.5 times greater than the stiffness of the first material, at least 3.0 times greater than the stiffness of the first material, at least 3.5 times greater than the stiffness of the first material, at least 4.0 times greater than the stiffness of the first material, at least 4.5 times greater than the stiffness of the first material, at least 5.0 times greater than the stiffness of the first material, at least 5.5 times greater than the stiffness of the first material, or at least 6.0 times greater than the stiffness of the first material. In some embodiments, the stiffness of the sole plate can be a bending stiffness (for example, a resistance of the sole plate to bending about an axis in response to an applied force). A flexural modulus is a measure of a bending stiffness of a material, where a higher flexural modulus indicates a higher resistance to bending. In some embodiments, the stiffness of the sole plate can be a compressive stiffness (for example, a resistance of the sole plate to deformation when subjected to a compressive force). An elastic modulus is a measure of a compressive stiffness of a material, where a higher elastic modulus indicates a higher resistance to deformation.

The different levels of stiffness of the second material in comparison to the first material described above can provide various advantages. For example, a stiffer material can make the sole plate more durable and resistant to damage or deformation under pressure or load as compared to a material with a lower stiffness. A material with high stiffness can help increase stability in the sole plate. Further, stiffer materials in the context of sole plates can enhance precision and accuracy. This can be advantageous when the sole plate is used for a shoe during running on an athletics track. That is, because in track and field events, a high accuracy can be helpful to reach a high level of performance. Furthermore, a high stiffness can help to avoid misalignment or displacement of the second material and/or its position can be predicted and/or maintained even under pressure or load to a greater extent as compared to a material with a lower stiffness. A stiffer material can make the sole plate more durable and resistant to damage or deformation under pressure or load as compared to a material with a lower stiffness.

Further, embodiments disclosed herein can provide for a softer and/or smoother touch down and foot strike to the lateral side of the sole plate, when the sole plate is for a right shoe. Further, embodiments disclosed herein can provide for a softer and/or smoother touch down and foot strike to the medial side of the sole plate, when the sole plate is for a left shoe.

In some embodiments, the sole plate can comprise a softer and/or less stiff material on the side of the sole plate which can come into contact with the ground first. The ground can be a track, such as a curved athletics track. Additionally or alternatively, the ground can be a ground on which an athlete walks or runs in preparation of a high-jump, or any other sports discipline in track and field sport events. Such a softer and/or less stiff material can allow for an improved move-in transition in the landing phase of the foot. Additionally or alternatively, the softer and/or less stiff material on the lateral side of the left sole plate and on the medial side of the right sole plate can enable the foot to naturally have a banking effect, for example when running around a bend.

In some embodiments of the sole plate for an article of footwear as described herein, the second material can have a greater hardness as compared to the first material.

This difference in hardness can have the advantage that the first material can be, for example, elastically deformed, while the second material can be less prone to deformation or the like. Thereby, the second material can provide for sufficient stability.

The second material being less prone to deformation can provide an improved running experience by providing the necessary bending stiffness. For example, the increased bending stiffness (as compared to that of the first material) can help an athlete in reducing kinetic energy lost, such as energy due to movement of the athlete. The sole plate can interact with the joints in the foot and ankles in the form of a lever against the forces put into the ground. In turn, this can minimize the ground contact time and can provide higher energy return, for example, in the forefoot of an athlete.

In some embodiments, the sole plate can be asymmetrical, which can provide increased flexibility on the side closest to the inner radius of the track on which an athlete is running. Advantages associated with an asymmetrical sole plate can become more pronounced when the sole plate is used for longer sprints, such as a 200 m or 400 m dash race that require running through the curves of the track. For example, the asymmetric sole plate can provide stiffness in locations of the sole plate where most needed, while at the same time muscle fatigue arising out of changing body position and form during the sprint can be counteracted.

In some embodiments of the sole plate for an article of footwear as described herein, the first material has a shore D hardness of at most 70 shore D, at most 65 shore D, or at most 60 shore D, and/or wherein the second material has a shore D hardness of at least 65 shore D, at least 70 shore D, or at least 72 shore D. In some embodiments, the difference in hardness between the first material and the second material can provide, at least in part, the advantages described above provided by the sole plate.

In some embodiments of the sole plate for an article of footwear as described herein, the second material can have a greater flexural modulus as compared to the first material.

This further contributes to the foregoing advantages set out in relation to the different functionalities that can be imparted to the first material and the second material of the sole plate.

In some embodiments of the sole plate for an article of footwear as described herein, the first material has a flexural modulus of at most 1000 MPa, at most 800 MPa, at most 600 MPa, at most 400 MPa, at most 300 MPa, or at most 250 MPa, and/or wherein the second material has a flexural modulus of at least 800 MPa, at least 900 MPa, at least 1000 MPa, at least 1100 MPa, at least 1200 MPa, at least 1300 MPa, at least 1400 MPa, or at least 1500 MPa. In some embodiments, the difference in flexural modulus between the first material and the second material can provide, at least in part, the advantages described above provided by the sole plate.

### Apertures of the Sole Plate

In some embodiments of the sole plate for an article of footwear as described herein, the one or more first apertures can have an elongated shape, such as a slit, a groove, a cut, and a vent.

The elongated shape of the one or more first apertures can aid in maintaining stability of the sole plate while the material (for example, comprising the first material and the second material) of the sole plate is configured to expand at least partially into the one or more apertures.

The elongated shape of the one or more first apertures can also improve ventilation, cooling, aesthetics, and/or functionality as compared to a sole plate with apertures having a different shape or no apertures at all. For example, ventilation provided by the one or more first apertures can limit accumulation of moisture. Limiting moisture accumulation can improve longevity of the sole plate and/or the article of footwear in general. Additionally or alternatively, the shapes of the one or more first apertures described herein can be sized such that no disturbing objects from the environment, such as pebbles or the like, can accumulate therein and/or can protrude therethrough (thereby limiting irritation to the wearer and increasing performance). Sizing the one or more first apertures to limit objects from protruding therethrough can be advantageous when no outsole is provided and/or when the sole plate is used as an outsole. In some embodiments, the sole plate can be segmented by the one or more first apertures. For example, the sole plate can comprise two or more segments that are at least partially separated by the one or more first apertures. In some embodiments, the two or more segments can meet and/or be joined at the one or more first apertures.

The one or more first apertures can additionally or alternatively have a segmented shape (for example, a shape that can comprise multiple, individual segments that are coupled together to form the one or more first apertures). For example, they can have a discontinuous shape (for example, a shape that can comprise discontinuous transitions between the different segments that comprise the one or more first apertures). In some embodiments, the discontinuous shape can be oriented along the heel to toe axis of the sole plate. In some embodiments, orienting the one or more first apertures along the heel to toe axis of the sole plate can provide lateral flexibility while maintaining stiffness in the length wise direction. A segmented shape or a discontinuous shape can provide several advantages. For instance, the one or more first apertures can be more flexible and can bend or conform to different shapes and/or load conditions that can occur during running as compared to a sole plate having a continuous shape. This is because the segments can move separately and independently from one another at least to a certain extent. Moreover, a segmented or discontinued shape can allow for greater customization as compared to a non-segmented or continuous shape, as individual segments of the one or more apertures can be designed and modified without affecting the entire aperture. Additionally or alternatively, various segments can be structured to serve different purposes. For example, some segments can have a wider or narrower extension in the transverse direction as compared to other segments. Further, in the event that a segmented or discontinuous aperture is damaged, the damage can be confined to a single segment thereof such that the entire aperture does not lose its effectiveness, thereby enhancing its reliability. Additionally or alternatively, a segmented or discontinuous shape can adjust better to any further functional elements provided in proximity to the one or more apertures as compared to a non-segmented or continuous shape. An example of such further functional elements can be receptacles for spikes. This can be of advantage in case a limited space is available. Further, the one or more first apertures can be designed so as to fit in the sole plate closely or accurately (for example, the individual segments can be coupled in such a way as to provide the desired fit). Further, segmented or discontinuous shapes can facilitate expansion and contraction (for example, the individual segments can be coupled in such a way as to provide relative movement between the individual segments to allow for expansion and contraction).

In some embodiments, a segmented shape or a discontinuous shape can be understood as a shape of the aperture in which different segments can be recognizable. Such segments can define a sub-aperture. In some embodiments, the segments can be connected by a material of the sole plate. In some embodiments, the sub-apertures are not connected and, therefore, can be regarded as discontinuous. In some embodiments discontinuous can refer to instances in which the sub-apertures are separate and distinct from one another. Regardless of whether the sub-apertures are discontinuous, the overall circumference of the sub-apertures can be within the material of the sole plate. In some embodiments, the overall perimeter of the sub-apertures can be oriented in one direction. In this manner, the sub-apertures, although being separate and distinct from one another, can form one group.

As described elsewhere herein in greater detail, regardless of the shape of the one or more first apertures, the one or more apertures can still have a closed boundary (for example, the one or more apertures can be enclosed by a periphery of the sole plate).

In some embodiments of the sole plate for an article of footwear as described herein, the one or more first apertures define through holes (for example, a hole runs completely through the material of an object). Through holes can impart certain functional properties to the sole plate. For example, through holes can aid in distributing pressure, which can be appreciated by an athlete performing his or her athletic activity. In addition, a part of a shoe behind the aperture can be visible from the bottom of the sole plate and/or of the article of footwear. This can simplify inspection of its state, integrity, or the like. For example, the part of the shoe behind the aperture could be at least partially touched or the like by a user. Such touching can be possible, for instance, when a respective shoe comprising the sole plate is not worn.

Further, through holes can facilitate the manufacturing of the article of footwear. In addition, the space provided for the material of the sole plate to expand can be increased (for example, the material can expand into and/or through the through holes). In addition, the one or more first apertures defining through holes can provide the advantage of reducing the weight of the sole plate, thereby reducing the overall weight of a shoe comprising said sole plate. A lightweight shoe can be advantageous when it is used for an athletic activity like running.

In some embodiments of the sole plate for an article of footwear as described herein, the one or more first apertures can extend in a longitudinal direction of the sole plate and in a transverse direction of the sole plate, wherein the extension in the longitudinal direction is preferably larger as compared to the extension in the transverse direction.

The one or more first apertures extending in the longitudinal direction by a larger amount compared to the transverse direction can provide the advantage that the firmness and/or the stability of the sole plate can be substantially maintained. Additionally or alternatively, the firmness and/or the stability of the sole plate is not substantially impaired. In either embodiment, the expansion of the material (comprising the first material and the second material) of the sole plate into and/or through the one or more apertures can be facilitated.

The longitudinal direction can be substantially parallel and/or the same as the heel to toe axis of the sole plate. The transverse direction can be substantially parallel and/or the same as the medial to lateral axis of the sole plate.

In some embodiments of the sole plate for an article of footwear as described herein, the one or more first apertures can be arranged in the first portion of the sole plate.

Arranging the one or more first apertures in the first portion of the sole plate can facilitate expansion of the first material. This can be beneficial, as the first material is less stiff compared to the second material. Accordingly, the first material is more likely to be deformed as compared to the second material. Thus, an improved cushioning can be provided to the wearer.

As described elsewhere herein, the first portion of the sole plate can be arranged on the lateral side of the sole plate when the sole plate is for a left shoe. Further, the first portion of the sole plate can be arranged on the medial side of the sole plate when the sole plate is for a right shoe.

### Second Apertures

In some embodiments of the sole plate for an article of footwear as described herein, the sole plate can comprise one or more second apertures arranged in the second portion of the sole plate.

The one or more second apertures can contribute to the foregoing advantages of the first apertures. For example, the provision of one or more second apertures arranged in the second portion could provide enhanced functionality, improved performance capabilities, and a greater versatility. More specifically, the one or more second apertures could be used for another, complementary function as compared to the one or more first apertures. Further, although the second material in the second portion can have a greater stiffness compared to the first material in the first portion, the second apertures can be configured such that the second material can at least partially deform into and/or through the one or more second apertures.

As described elsewhere herein, the same features (including but not limited to the shapes, direction of expansion, or the like) and advantages described with reference to the “one or more first apertures” can equally apply to the “one or more second apertures.” For brevity, repetition of these features and advantages is omitted.

In some embodiments, the one or more second apertures can be spaced apart from the one or more first apertures on opposing sides of a heel to toe midline of the sole plate (said heel to toe midline can extend along the heel to toe axis of the sole plate). However, the arrangement of the one or more second apertures in relation to the one or more first apertures is not limited to this particular example.

In some embodiments of the sole plate for an article of footwear as described herein, the number of the one or more first apertures can be greater than the number of the one or more second apertures.

The configuration of having a greater number of first apertures than second apertures can have several advantages. For example, the configuration can provide for a more balanced functionality. Deformation of the first material (a first function) in the first portion through the greater number of first apertures can provide cushioning for a runner. Further, a secondary or complementary function can be performed via the fewer second apertures. This can achieve balance between different functions and can improve overall effectiveness. In some embodiments, more of the first apertures can be provided in the first portion (as compared to the number of second apertures provided in the second portion) where they can be helpful in improving cushioning and/or performance of a runner. Moreover, the number of apertures can reflect a priority of the functions. For example, the first apertures can be made for a more frequently used function (for example, cushioning). Thus, having more of these first apertures (as compared to the second apertures) can ensure efficient performance of that function. The difference in the number of apertures can also provide asymmetric functionality and, thereby, improve the sole plate's performance. Additionally or alternatively, by limiting the number of second apertures, it can be possible to reduce unwanted or less desirable effects that can occur if both the first apertures and the second apertures were equally numerous. Further, in some embodiments, the first material (e.g., the less stiff material) can deform to a greater extent compared to the second material (e.g., the stiffer material).

In some embodiments of the sole plate for an article of footwear as described herein, the number of the one or more first apertures is different than the number of the one or more second apertures. As understood, this can contribute to the advantages mentioned above.

### Spikes

In some embodiments of the sole plate for an article of footwear as described herein, one or more spikes can be arranged on the sole plate, such as on a forefoot portion of the sole plate. In some embodiments, the sole plate can comprise one or more receptacles, wherein the one or more receptacles can be arranged on the sole plate, such as on a forefoot portion of the sole plate, wherein the one or more receptacles can be configured to receive the one or more spikes.

The one or more spikes can face a ground during use of the sole plate. The one or more spikes can provide several advantages. For instance, the one or more spikes can improve traction, which can help the wearer to grip the ground more efficiently. This can be the case on any kind of ground, such as on soft grounds that can be used for athletics tracks. Further, the one or more spikes can help the wearer to accelerate, decelerate, and change directions more quickly and securely as compared to sole plates that do not comprise spikes. This can enhance performance when the sole is used for a shoe during running such as running on an athletics track. This can also enhance performance of an athlete performing a high-jump or any other sports discipline in track and field sport events, such as those that involve running or accelerating on a curved track. The one or more spikes can also provide better stability to the foot as compared to sole plates that do not comprise spikes, making it easier to maintain balance. In activities like running, spikes on the forefoot of the sole plate can help the wearer to push off the ground more effectively, thereby facilitating better energy transfer and potentially optimizing performance. Moreover, spikes on the forefoot of the sole plate can encourage the wearer to land more on a forefoot rather than a heel, which can reduce the risk of injuries and improve running efficiency.

In some embodiments, the sole plate can comprise one or more receptacles that can be arranged on the sole plate, such as on a forefoot portion of the sole plate. The one or more receptacles can be configured to receive the one or more spikes to engage with the one or more spikes. Such engagement can provide a firm fit between the sole plate and the one or more spikes.

In some embodiments of the sole plate for an article of footwear as described herein, the one or more first apertures and/or the one or more second apertures can be arranged between two or more of the one or more spikes, and/or wherein the one or more spikes can be arranged between two or more first apertures and/or two or more second apertures.

Such arrangements of the one or more spikes can improve traction with the ground due to the arrangement of the one or more spikes in relation to the one or more first and/or second apertures. Further, arranging the one or more first apertures and/or the one or more second apertures in proximity to the one or more spikes can improve expansion of the first material and/or the second material into and/or through the respective apertures (for example, due to the pressure acting on the spikes during running).

### Dimensions and General Features

In some embodiments of the sole plate for an article of footwear as described herein, the one or more first apertures and/or the one or more second apertures have a length, such as in a longitudinal direction of the sole plate, of at least 1 cm, at least 2 cm, at least 3 cm, at least 4 cm, at least 5 cm, at least 6 cm, at least 7 cm, at least 8 cm, at least 9 cm, at least 10 cm, at least 11 cm, at least 12 cm, at least 13 cm, at least 14 cm, or at least 15 cm, and/or the one or more first apertures and/or the one or more second apertures have a length, such as in a longitudinal direction of the sole plate, of at most 25 cm, pat most 23 cm, at most 20 cm, at most 19 cm, at most 18 cm, at most 17 cm, at most 16 cm, or at most 15 cm.

With the lengths of the one or more first apertures and/or the one or more second apertures as specified herein, a balance can be struck between the following conflicting requirements. On the one hand, sufficient expansion of the material (comprising the first material and the second material) of the sole plate can be provided for cushioning, which can reduce a pressure on the wearer and can make ground contact more comfortable to the wearer. To provide for sufficient expansion, a longer length of the sole plate can be desirable. On the other hand, sufficient support and/or stability to the foot of the wearer can be provided, which can reduce a transition in the horizontal direction upon landing. To provide for sufficient support, a shorter length of the sole plate can be desirable. Thus, the lengths provided above can provide for a sole plate with a sufficient length to provide both cushioning and support for the wearer.

In some embodiments, the longitudinal direction of the sole plate can be substantially parallel to a heel to toe axis of the sole plate.

In some embodiments of the sole plate for an article of footwear as described herein, the sole plate can have a maximum thickness of at most 10 mm, at most 9 mm, at most 8 mm, at most 7 mm at most 6 mm, at most 5 mm, at most 4 mm, or at most 3 mm.

The thickness of the sole plate can provide various advantages. For example, the sole plate may not act and/or feel like a bulky object of the article of footwear. Rather, the sole plate can feel like it is smoothly integrated with the article of footwear, which the wearer can appreciate. Further, a lower thickness can be advantageous as material usage can be reduced, which can have economic and ecological advantages. In addition, a lower thickness can contribute to a lightweight shoe while still providing stability to the foot of the wearer.

In some embodiments, the thickness of the sole plate can be measured substantially along a vertical axis when the sole plate is used according to its ordinary use. For example, the thickness of the sole plate can be measured from the top to bottom or from the bottom to top, as seen from the perspective of the wearer.

In some embodiments, the sole plate can comprise a varying thickness, which could contribute to a tapered shape of the sole plate. By varying the thickness of the sole plate, various different effects can be achieved in different portions of the sole plate. Thus, the stiffness, hardness, and/or flexural modulus of the sole plate can be can vary in different locations on the same sole plate.

In some embodiments of the sole plate for an article of footwear as described herein, the sole plate can be a single, integrally formed piece extending from a heel region of the sole plate to a toe region of the sole plate. For example, the sole plate can extend from a heel region of a foot of a wearer to a toe region of a foot of a wearer when a shoe comprising the sole plate is worn by the wearer during ordinary use.

Integrally forming the sole plate as a single piece (for example, a monolithic or integral design) can offer several advantages. For example, an integrally formed piece can be stronger and more durable as compared to an assembly of multiple components because an integrally formed piece can have fewer points of weakness and/or potential failure as compared to an assembly of multiple components. Further, an integrally formed piece may be simpler and easier to manufacture and/or to assemble as compared to an assembly of multiple components because an integrally formed piece can substantially eliminate the need for separate parts, fasteners, or connectors (which can also lead to cost savings in production). Moreover, an integrally formed piece can reduce the overall weight of the resulting sole plate as compared to an assembly of multiple components. Reducing the weight of the sole plate can be advantageous in the context of sports shoes, where weight savings can play a significant role. Further, an integrally formed piece can provide improved performance as wearing, vibration, and/or noise associated with separate moving parts (such as those that can be present in an assembly of multiple components), or the like can be reduced or eliminated. In addition, by eliminating the need for additional components, parts, elements, or the like, an integrally formed piece can reduce material costs, labor costs, and/or assembly time, resulting in cost savings as compared to an assembly of multiple components. Furthermore, fewer components associated with an integrally formed piece can provide for simplified constructions, which could lead to reduced material waste during production and disposal as compared to an assembly of multiple components, which can contribute to more sustainable and eco-friendly sole plates as compared to an assembly of multiple components.

### Method

In some embodiments, the objects of the present disclosure are at least partially solved by a method for manufacturing one or more sole plates for one or more articles of footwear, such as a running shoe, the method comprising: providing a mold; injecting a first material into the mold; and injecting a second material into the mold; wherein injecting the first material and injecting the second material takes place at least partially at the same time.

Any one or more of the embodiments, features, advantages, examples or the like as described herein with reference to the embodiments relating to the sole plate can be combined with the embodiments relating to the method and vice versa. For example, the technical properties shown or described for the sole plate, and the advantages and the improvements associated therewith are likewise applicable to the method and vice versa.

In some embodiments, the method can comprise a multiple injection process, such as a dual-injection process. The dual-injection process can mean that two materials can be used for injecting. For example, two feed lines of materials can be employed as described elsewhere herein. However, the method is not limited thereto, and more or fewer materials can be employed for injecting.

The method disclosed herein is not limited in the number of injection nozzles. The injection nozzles can be understood as a final part of a feed line through which material is injected into the mold. For example, one, two, three, four, five, fix, seven, eight, nine, ten, or more injection nozzles can be employed for injecting the first material and/or for injecting the second material.

In some embodiments, injecting the first material and injecting the second material can take place at least partially at the same time. This can comprise instances in which the injecting steps only partially overlap over time. For example, injecting the first material can start before starting to inject the second material. As another example, injecting the first material can start after starting to inject the second material. Regardless of the order in which the injections start, both injection steps can have a time span that overlaps. In some embodiments, injecting the first material and injecting the second material can take place at the same time. For example, injecting the first material can start at the same time as injecting the second material, and injecting the first material can end at the same time as injecting the second material.

By injecting the first material and injecting the second material at least partially at the same time, various disadvantages of single injection processes can be overcome. For example, injecting the first material and the second material at least partially at the same time facilitates usage of different materials (for example, the first material and the second material). Using different materials injected at least partially at the same time can have the advantage that more functionalities can be provided, such as in one integrally injected piece.

In addition, by injecting the first material and the second material at least partially at the same time, the method of manufacturing can reduce the overall manufacturing time as compared to a method that injects materials sequentially, which can lead to increased productivity and cost savings. Moreover, injecting the first material and the second material at least partially at the same time can result in a more homogenous mix and/or a better controlled reaction between the first material and the second material, improving product quality, as compared to a method in which the first material and the second material are not injected at least partially at the same time. Further, if the first material and the second material react with each other, injection thereof at least partially at the same time can prevent potential issues such as premature hardening or degradation of one material before the other material is introduced. Further still, injecting the first material and the second material at least partially at the same time can reduce the chance of contamination that could occur if there was a time lapse between the injection of the first material and injecting the second material. Injecting the first material and the second material at least partially at the same time could also reduce labor costs or the need for complex machinery that would otherwise be required for sequential injection.

The described method has the further advantage that all the beneficial functions described herein with reference to the sole plate can be achieved through substantially one engineered piece (for example, one integrally formed or injected piece) in substantially one process step.

In some embodiments of the method as described herein, the first material can be different than the second material, which can have the advantage of providing different functionalities across a single sole plate.

In some embodiments of the method as described herein, the second material can have a greater stiffness as compared to the first material, which can provide similar advantages as previously described.

In some embodiments of the method as described herein, the method can comprise forming a first sole plate and a second sole plate at the same time.

Forming a first sole plate and a second sole plate at the same time during manufacturing process can present several advantages. For example, simultaneous formation of both sole plates can improve the production process efficiency, potentially yielding higher output in less time. Further, forming the two sole plates simultaneously can save costs associated with labor, time, and energy consumption. This cost efficiency can lead to overall reduced production costs. Further, forming the first sole plate and the second sole plate at the same time can ensure consistency between the two sole plates, as they would be made under substantially the same conditions at the same time. This could contribute to the overall quality and uniformity of the sole plates, such as when the two sole plates are used for a pair of shoes. Moreover, forming the first sole plate and the second sole plate at the same time can simplify the process flow by eliminating the need to complete one part before starting with another. This can reduce production steps and possible machine downtime. Furthermore, utilization of the production capacity can be better when producing two parts simultaneously, ultimately leading to higher profitability.

When reference is made herein to forming a first sole plate and a second sole plate “at the same time,” minor variations regarding the specific time periods for each sole plate are considered. For instance, depending on the environmental conditions and/or specific material compositions, it can be the case that forming one of the sole plates can take slightly longer or slightly shorter as compared to the other sole plate. This means that manufacturing tolerances should be included. Regardless of whether forming one of the sole plates takes slightly longer or shorter than the other sole plate, when the injection steps are performed and, subsequently, the mold is opened, both sole plates are considered to be formed at the same time.

In some embodiments of the method as described herein, the first sole plate can be a sole plate for a right shoe and the second sole plate can be a sole plate for a left shoe. This can further contribute to the foregoing advantages set out in relation to the first sole plate and the second sole plate. For example, this can lead to an improved performance to the wearer of the shoes, such as when they are used for running during track and field events.

In some embodiments of the method as described herein, the first sole plate can comprise: a first portion arranged on a medial side of the first sole plate; and a second portion arranged on a lateral side of the first sole plate; wherein the second sole plate can comprise: a first portion arranged on a lateral side of the second sole plate; and a second portion arranged on a medial side of the second sole plate; wherein injecting the first material can comprise injecting the first material in the first portion of the first sole plate and in the first portion of the second sole plate, and wherein injecting the second material can comprise injecting the second material in the second portion of the first sole plate and in the second portion of the second sole plate.

In some embodiments, this method can provide similar advantages as described elsewhere herein. For example, the sole plates can be asymmetrical, as they can have a difference in geometry and/or in materials and/or in material properties. As another example, a stiffer and/or harder material can be provided on a lateral side of one shoe (such as a right shoe) and on a medial side of another shoe (such as a left shoe). Furthermore, a less stiff and/or softer material can be provided on a medial side of the one shoe (such as a right shoe) and on a lateral side of the other shoe (such as a left shoe). Thus, the sole plate can have the benefit that a less stiff and/or softer material can be provided on the side of the sole plate which can come into contact with the ground first.

In some embodiments of the method as described herein, the first sole plate and the second sole plate can form an asymmetric pair of sole plates.

This contributes to the advantages mentioned elsewhere herein. For example, in a conventional pair of shoes, a right shoe can be mirrored to a respective left shoe, which can provide the same functionality and/or symmetrical functionalities to each foot of the wearer. However, when used for instance during running a curve or the like, such a design may not lead to optimum results. Rather, some types of running, such as running a curve or the like, can lead to an asymmetrical movement of each foot of the wearer. Hence, providing for a respective asymmetric pair of sole plates can improve performance to the wearer.

The advantage of having an asymmetric pair of sole plates, where the first sole plate and the second sole plate are not identical, lies in the specialized functions they can provide. The differences in the sole plates can enable different performance characteristics and/or different functionalities and can vary depending on the specific features of each sole plate. The asymmetry can help in enhancing performance for the wearer as compared to symmetric sole plates, providing better comfort and reducing the risk of injury, and adapting better to specific characteristics and needs of each foot, considering that foot biomechanics are not necessarily symmetrical.

As described, the asymmetric pair of sole plates can provide for the difference in needs of each foot when moving in a certain way, such as when running in a specific direction of a track. Alternatively or additionally, the asymmetric pair of sole plates can have benefits if the athlete is running in a specific running condition.

Two sole plates can be considered symmetric when the sole plates have symmetry about a common axis. For example, one sole plate can be a mirror image of the respective other sole plate. Two sole plates can be considered asymmetric when the sole plates do not have symmetry about a common axis. More specifically, there may be no axis about which the two sole plates have symmetry. Put differently, in an asymmetric pair of sole plates, a mirror of one sole plate does not match the respective other sole plate.

In some embodiments of the method as described herein, injecting the second material can comprise using more injection nozzles compared to injecting the first material.

By using more injection nozzles to inject the second material than the first material, the second material in the second portion can be provided with a greater stiffness. For instance, more material can be provided at the same time as compared to using less injection nozzles. This additional material can provide the increase in stiffness (for example, by way of an increased density). More specifically, by using more nozzles, a greater volume of material can be provided at substantially the same time to the second portion as compared to the first portion. In this manner, any losses in the injection nozzles (such as frictional losses) can be reduced, because the velocity of injection can be reduced to a certain extent.

Sole Plate from Method

In some embodiments of the present disclosure, the objects are at least partially solved by a sole plate for an article of footwear, such as for a sports shoe such as a running shoe, the sole plate being manufactured according to the any one of the embodiments of the method as described in here.

The technical properties, improvements, and advantages shown or described elsewhere herein for the sole plate for an article of footwear are likewise applicable to the sole plate manufactured according to the method described herein.

For example, injecting the first material and injecting the second material at least partially at the same time can lead to an improved material composition of the sole plate as compared to injecting material sequentially. In some embodiments, cooling and, thereby, hardening of the first material and the second material can take place at substantially the same time, which can provide a specific structure of the sole plate. Moreover, injecting the first material and the second material at least partially at the same time can result in a more homogenous mix and/or a better controlled reaction between the first material and the second material as compared to injecting material sequentially. This can lead to an improved product quality, which distinguishes the sole plate so produced from sole plates made from other methods.

Furthermore, the methods described herein provide for a seamless transition from one material to the other material (for example, from the first material to the second material and/or from the second material to the first material).

### Apparatus

In some embodiments, the objects are at least partially solved by an apparatus for manufacturing one or more sole plates for one or more articles of footwear, such as for a sports shoe such as a running shoe, the apparatus comprising means for performing a method according to any one of the embodiments described herein.

The respective features and advantages as mentioned with respect to the method for manufacturing one or more sole plates for one or more articles of footwear are also applicable to the apparatus.

In some embodiments, the apparatus can comprise a mold, one or more first injection nozzles for injecting the first material, one or more second injection nozzles for injecting the second material, and a controller configured to control injecting, such that injecting the first material and injecting the second material can take place at least partially at the same time. In some embodiments, the apparatus can comprise a cover for covering the mold at least partially.

A manufacturing apparatus designed as described above can take up only a relatively small amount of building space and can allow the manufacture to be automated to a large extent, which can be suitable for series and mass production. The various manufacturing parameters can also be individually adjusted so that individualized sole plates can be manufactured using a single manufacturing apparatus.

### Materials

In some embodiments of the sole plate for an article of footwear as described herein, the first material can comprise one or more of the following: polyamide (PA), polyurethane (PU), or thermoplastic polyurethane (TPU), and/or wherein the second material can comprise one or more of the following: polyamide (PA), fiber-reinforced PA, or carbon fiber-reinforced PA, wherein the carbon content by weight is at least 1%, at least 2%, more at least 4%, or at least 6%.

These materials have the advantage to provide sufficient stiffness, hardness, and/or flexural modulus as described elsewhere herein. Further, these materials can contribute to an enhanced performance for the wearer when a shoe comprising a sole plate is worn. In addition, these materials are relatively easy to procure, are cost-effective, and are widely accepted in the sector of soles for shoes.

### Article of Footwear

In some embodiments, the objects are at least partially solved by an article of footwear, such as a sports shoe such as a running shoe, where the article of footwear can comprise: a sole plate as described in any one of the embodiments described herein; and an upper; wherein the sole plate can be attached to the upper.

Since the article of footwear of such embodiments can comprise the sole plate for an article of footwear as described herein, the technical properties, advantages, and improvements shown or described for the sole plate for an article of footwear are likewise applicable to the article of footwear and vice versa.

In some embodiments, the sole plate can be attached to the upper by any kind of suitable attachment. Attaching the sole plate to the upper of a shoe can involve various methods and techniques depending on the type of shoe, the materials used, and/or the desired level of durability and robustness of the upper.

In some embodiments of the article of footwear as described herein, the article of footwear can be a running shoe, such as a running shoe used for athletics tracks. Such shoes can be used, for example, during track and field events. As noted elsewhere herein, the article of footwear can be used for any kind of athletic activity. When used for running (such as for running on athletics tracks), the advantages are even more pronounced than when used for other activities. Alternatively or additionally, the advantages are pronounced when used for high-jump or any other sports discipline in track and field sport events.

### Pair of Shoes

In some embodiments, the objects are at least partially solved by a pair of shoes that can comprise a right shoe and a left shoe, wherein the right shoe can comprise a first sole plate as described in any one of the embodiments herein; and wherein the left shoe can comprise a second sole plate as described in any one of the embodiments herein.

Since the pair of shoes of such embodiments can comprise a first sole plate and a second sole plate for an article of footwear as described elsewhere herein, the technical properties, advantages, and improvements shown or described for the sole plate for an article of footwear are likewise applicable to the pair of shoes and vice versa.

### DESCRIPTION OF FIGURES

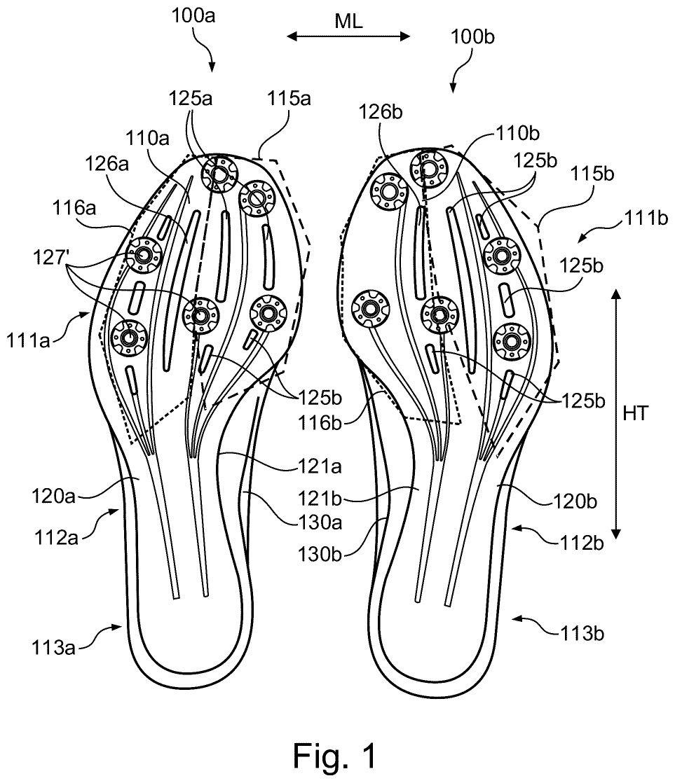

FIG. 1 shows a first sole plate 110a and a second sole plate 110b, each respectively for an article of footwear, in particular for a sports shoe 100a (a right shoe), 100b (a left shoe), according to some embodiments.

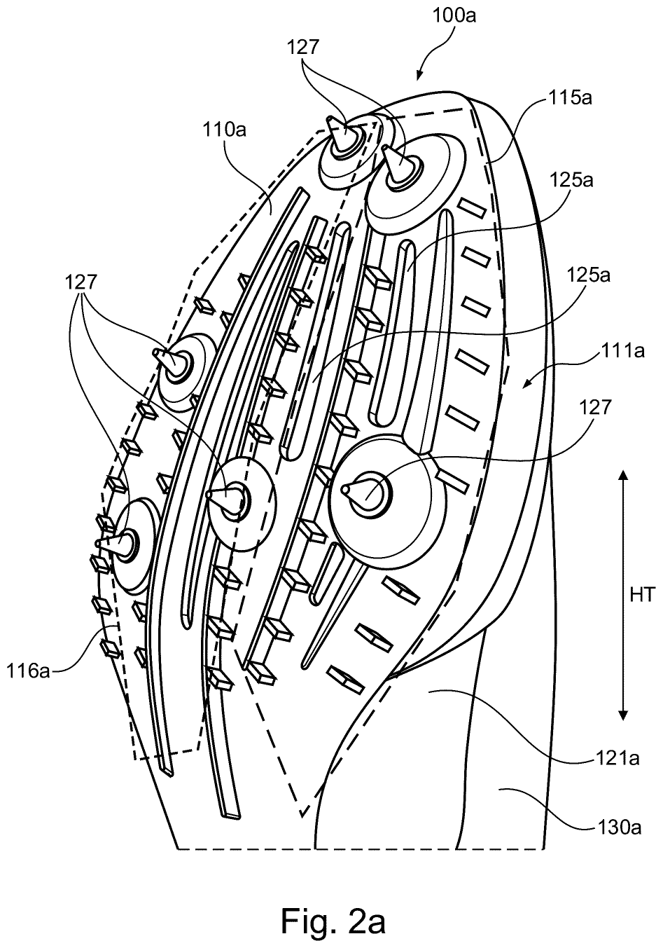

In some embodiments, the sole plate 110a, 110b can comprise a first portion 115a, 115b (indicated in an exemplary manner by way of the dashed boxes) that can comprise a first material 115c (as indicated in FIG. 3). In some embodiments, the sole plate 110a, 110b can comprise a second portion 116a, 116b (indicated in an exemplary manner by way of the dotted boxes) that can comprise a second material 116c (as indicated in FIG. 3). The second material 116c can have a greater stiffness than the first material 115c. When the sole plate 110a, 110b is for the right shoe 100a, the first portion 115a can be arranged on a medial side 121a of the sole plate 110a and the second portion 116a can be arranged on a lateral side 120a of the sole plate 110a. Additionally or alternatively, when the sole plate 110b is for the left shoe 100b, the first portion 115b can be arranged on a lateral side 120b of the sole plate 110b and the second portion 116b can be arranged on a medial side 121b of the sole plate 110b. In some embodiments, as shown in FIG. 1, the sole plate 110a, 110b can comprise one or more first apertures 125a, 125b.

In some embodiments, the sole plate 110a can be a first sole plate 110a, corresponding to the right sole plate 110a (for example, the sole plate 110a for the right shoe 100a). In some embodiments, the sole plate 110b can be a second sole plate 110b, corresponding to the left sole plate 110b (for example, the sole plate 110b for the left shoe 100b).

As described elsewhere herein, when running on an athletics track, such as during a track and field event, the runners typically run on a curved track. This can be the case when they run in a counterclockwise direction on the athletics track. When running in the counterclockwise direction, the runners tend to lean inwards toward their left sides. Accordingly, this lean should be considered when designing footwear for runners. The sole plate 110a, 110b for the shoe 100a, 100b, as proposed herein, can account for the tendency of runners to lean toward their left sides when running on a track. More specifically, the sole plate 110a, 110b can account for impacts occurring during running on athletics tracks. Additionally or alternatively, similar advantages can be achieved when an athlete is running on a curved track in preparation for high-jump or any other sports discipline in track and field sport events.

In some embodiments, the second material can have a stiffness as compared to the first material of at least 1.1 times greater than the stiffness of the first material, at least 1.2 times greater than the stiffness of the first material, at least 1.5 times greater than the stiffness of the first material, at least 2.0 times greater than the stiffness of the first material, at least 3.0 times greater than the stiffness of the first material, at least 4.0 times greater than the stiffness of the first material, at least 5.0 times greater than the stiffness of the first material, or at least 6.0 times greater than the stiffness of the first material.

In some embodiments, the second material can have a greater hardness as compared to the first material. For example, the first material can have a shore D hardness of at most 70 shore D, at most 65 shore D, or at most 60 shore D, and/or the second material can have a shore D hardness of at least 65 shore D, least 70 shore D, or at least 72 shore D.

The shore D hardness can be determined using a durometer, such as a device that presses a specific indenter into the surface of the material and measures the depth of indentation. In this manner, a force of the device can be fixed, and the depth may be measured for the fixed force.

The shore D scale is commonly used for harder materials, while the shore A scale is commonly used for softer materials. Measuring the shore D hardness can provide insight into the material's flexibility, resilience, and suitability for various applications. The shore D scale ranges from 0 to 100, with higher numbers indicating greater hardness.

In some embodiments, the first material can comprise a polyether block (for example, PEBAX® 63R53), being a thermoplastic elastomer made of flexible polyether and rigid polyamide. The first material can be manufactured from renewable resources. In some embodiments, the first material can have a hardness of 60 shore D. In some embodiments, the second material can comprise a fiberglass reinforced polyamide (for example, RILSAN® BZM 7). The second material can be manufactured from renewable resources. In some embodiments, the second material can have a hardness of 72 shore D.

In some embodiments, the second material can have a greater flexural modulus as compared to the first material. For example, the first material can have a flexural modulus of at most 1000 MPa, at most 800 MPa, at most 600 MPa, at most 400 MPa, at most 300 MPa, or at most 250 MPa, and/or the second material can have a flexural modulus of at least 800 MPa, at least 1000 MPa, at least 1200 MPa, at least 1300 MPa, at least 1400 MPa, or at least 1500 MPa. In some embodiments, the first material can have a flexural modulus of about 245 MPa. In some embodiments, the second material can have a flexural modulus of about 15000 MPa.

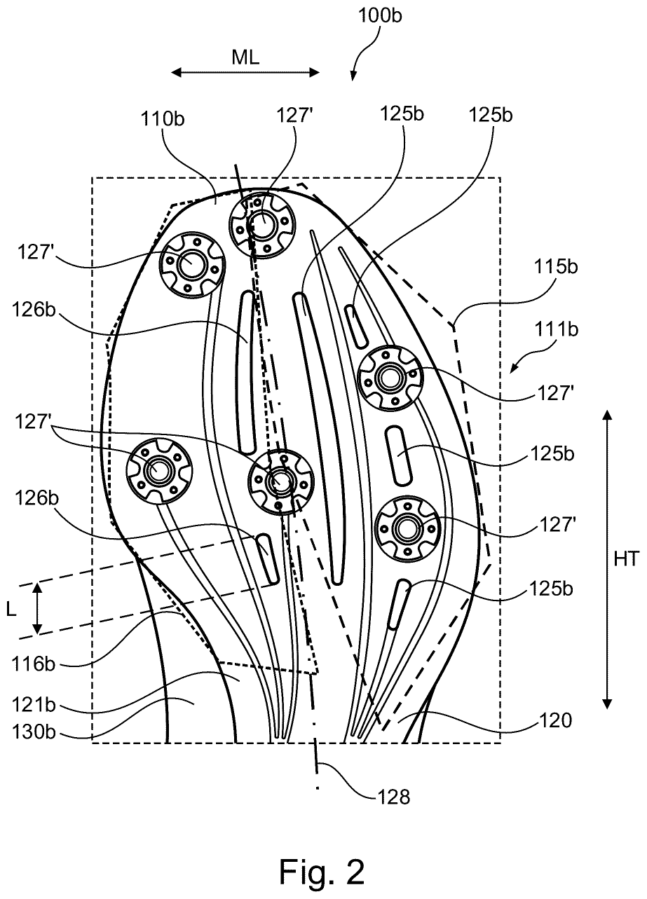

In some embodiments, as shown in FIG. 2a (but also derivable by way of one or more receptacles 127′ shown in FIG. 1 and FIG. 2), the sole plate 110a, 110b can comprise one or more spikes 127 that are arranged on the sole plate 110a, 110b, such as on a forefoot portion 111a, 111b of the sole plate 110a, 110b. In some embodiments, as shown in FIG. 1 and FIG. 2, the sole plate 110a, 110b can comprise one or more receptacles 127′ that are arranged on the sole plate 110a, 110b, such as on the forefoot portion 111a, 111b of the sole plate 110a, 110b. The one or more receptacles 127′ can be configured to receive the one or more spikes 127.

Although the one or more spikes 127 (as shown in FIG. 2a) can be arranged on the forefoot portion 111a, 111b of the sole plate 110a, 110b, in some embodiments the one or more spikes 127 can be arranged additionally or alternatively on different portions (for example, 112a, 112b, 113a, 113b) of the sole plate 110a, 110b. For example, the one or more spikes 127 can additionally or alternatively be arranged on a midfoot portion 112a, 112b of the sole plate 110a, 110b. As another example, the one or more spikes 127 can additionally or alternatively be arranged on a rearfoot portion 113a, 113b of the sole plate 110a, 110b.

In some embodiments, the one or more spikes 127 can be arranged so as to follow a certain pattern that is designed such that traction to the ground can be improved. In some embodiments, the arrangement of the one or more spikes 127 can comprise one or more groups of spikes 127 that can be arranged arbitrarily and one or more groups of spikes 127 that can be arranged so as to follow a certain pattern that is designed such that traction to the ground can be improved. The arrangement of the one or more spikes 127 can vary depending on the type of ground for which the sole plate 110a, 110b is made to be used.

In some embodiments, the one or more spikes 127 (as shown in FIG. 2a) can be attached to the sole plate 110a, 110b and/or to the one or more receptacles 127′. The one or more spikes can be attached to the sole plate 110a, 110b, and/or to the one or more receptacles 127′ using one or more or all of the following non-exhaustive list of components: fasteners (such as screws, bolts, nuts, rivets, clamps, staples, etc.), adhesives and glues (various types of adhesive substances can bond together when they dry or cure, a double-sided tape comprising adhesive on both sides of a tape), welding (melting portions of the parts at least partially and fusing them together), soldering (melting a low-temperature part for joining), mechanical connections (latches and catches, hooks and loops, zip ties, etc.), magnetic attachments, snap-fit connections (interlocking components that snap together). The specific component(s) used for attaching the spikes 127 to the sole plate 110a, 110b can depend on the materials involved and/or the specific intended purpose.

In some embodiments, the one or more spikes 127 can be fixedly attached to the sole plate 110a, 110b (for example, such that they are not removable from the sole plate 110a, 110b). In some embodiments, the one or more spikes 127 can be removably attached to the sole plate 110a, 110b (for example, the one or more spikes 127 can be screwed in to the sole plate 110a, 110b, such that they are removable).

As can be seen in FIG. 1 and in FIG. 2, in some embodiments, the one or more first apertures 125a, 125b and/or the one or more second apertures 126a, 126b can be arranged between two or more of the spikes 127 and/or two or more of the receptacles 127′. For instance, the largest first aperture 125b can be indicated as 125b′ as shown in FIG. 2 and can have a spike 127 on its lateral side 120b (to the right-hand side in FIG. 2) and a spike 127 on its medial side 121b (to the left-hand side in FIG. 2). As can be further seen in FIG. 1, FIG. 2, and FIG. 2a, one or more spikes 127 and/or one or more of the receptacles 127′ can be arranged between two or more first apertures 125a, 125b and/or between two or more second apertures 126a, 126b. For instance, the three lateral most first apertures 125b can be indicated as 125b″ as shown in FIG. 2 and can have receptacles 127′ and/or spikes 127 arranged between each of two pairs of these three first apertures 125b″.

FIG. 2 shows a detailed view of FIG. 1, according to some embodiments. For brevity, only the left shoe 100b and, correspondingly, the left sole plate 110b is shown and described. The description of the left shoe 100b and the left sole plate 110b can be applied to the right shoe 100a and the right sole plate 110a.

In some embodiments, when the sole plate 110a, 110b is for the left shoe 100b, the first portion 115b can be arranged on the lateral side 120b of the sole plate 110b and the second portion 116b can be arranged on the medial side 121b of the sole plate 110b. This can be seen when viewing the heel to toe midline 128 of the sole plate 110b as shown in FIG. 2 by way of the dash dotted line passing along the heel to toe axis HT. The midline 128 of the sole plate 110b can separate the sole plate 110b in substantially two halves (for example, about a half on the medial side 121b and about a half on the lateral side 120b). As understood by the skilled person, the half on the medial side 121b and on the lateral side 120b of the sole plate 110b can in some cases slightly vary (for example, not be exactly equal to one half on either side of the midline 128), as the sole plate 110b can be asymmetric. This variation is expressed by the term “about.” The first portion 115a and the second portion 116a can be similarly arranged for the sole plate 110a when being used for a right shoe 100a. This is also explained with respect to FIG. 1.

In some embodiments, although the first portion 115b can be arranged on the lateral side 120b of the sole plate 110b and the second portion 116b can be arranged on the medial side 121b of the sole plate 110b, part of the first material can be located on the medial side 121b of the sole plate 110b in proximity to the midline 128. This can be seen by the dashed box indicating the arrangement of the first portion 115b and the dash dotted midline 128 in FIG. 2. Additionally or alternatively, part of the second material can be located on the lateral side 120b of the sole plate 110b in proximity to the midline 128. This can be seen by the dotted box indicating the arrangement of the second portion 116b and the dash dotted midline 128 in FIG. 2.

As can be seen in FIG. 2 and FIG. 1, the one or more first apertures 125a, 125b can have an elongated shape, such as a shape of one of a slit, a groove, a cut, and a vent. As noted elsewhere herein, these shapes of the apertures 125a, 125b can contribute to the advantage that the stability of the sole plate 110a, 110b can be substantially maintained while the material of the sole plate 110a, 110b is configured to expand at least partially into the one or more first apertures 125a, 125b. In addition, the specific shapes can be described as follows and can have the following advantages: in some embodiments, a slit can be a long, narrow opening and/or a cut in a material of the sole plate 110a, 110b. A slit can have a length that is greater than its width, in some instances its length can be significantly greater than its width. For example, its length can be greater than its width by a factor of at least two, at least three, at least four, at least five, at least six, at least seven, at least eight, at least nine, at least ten or even greater. Slits can be straight or curved and they can comprise one or more straight segments and one or more curved segments. The segments can be arbitrarily arranged along a line or in an alternating manner along a line. Slits can be used to allow passage or flow of air, light, or other substances therebetween. Additionally or alternatively, the slits can provide for additional functionalities (for example, they can contribute to the outer appearance).

In some embodiments, a groove can be a long, narrow channel and/or recessed portion, which can be cut into a material of the sole plate 110a, 110b. The grooves can be useful for various purposes, such as guiding the flow of liquids, or the like, which can aid in removing moisture resulting from sweat or the like. Removing moisture can reduce odors associated with accumulated moisture. The grooves can be wide or narrow and can have a variety of shapes, including one or more of straight segments, curved segments, corner segments, regular segments, or irregular segments. The segments can be arbitrarily arranged along the longitudinal direction of the groove or in an alternating manner along the longitudinal direction of the grove.

In some embodiments, a cut can refer to a separation or division made in a material, such as a material of the sole plate 110a, 110b described herein. Cuts can be straight or angled and can be used for a wide range of purposes, including creating openings, shaping materials, or altering the structure of the sole plate 110a, 110b. The cuts can appear in a variety of shapes, including one or more of straight segments, curved segments, corner segments, regular segments, or irregular segments. The segments can be arbitrarily arranged along the longitudinal direction of the cut or in an alternating manner along the longitudinal direction of the cut.

In some embodiments, a vent can refer to an opening or passage in a material, such as a material of the sole plate 110a, 110b as described herein. A vent can allow for the movement of gases (such as air), or liquids therethrough. Vents can be useful in regulating a temperature of the foot of the wearer. The vents can be implemented by various different shapes and/or size sizes, including one or more of straight segments, curved segments, corner segments, regular segments, or irregular segments. The segments can be arbitrarily arranged along the longitudinal direction of the vent or in an alternating manner along the longitudinal direction of the vent.

Regardless of the shape of the one or more first apertures 125a, 125b, the one or more first apertures can have a closed boundary (for example, the one or more first apertures 125a, 125b can be enclosed by a periphery of the sole plate 110a, 110b).

The three lateral most first apertures 125b (indicated as 125b″ in FIG. 2) can illustrate an example of a segmented and/or a discontinued shape described elsewhere herein, according to some embodiments. The three first apertures 125b″ can be regarded as three separate segments, which can have an asymmetric shape (for example, one or more of the first apertures 125b″ can be wider or narrower in the transverse direction (that is substantially parallel to the medial to lateral axis ML) along the length of the one or more first apertures 125b″) as compared to other segments of the three first apertures 125b″. FIG. 2 also shows by way of the first apertures 125b″ that the available space of the sole plate 110b can be used to an optimum degree. This is particularly of advantage, as the sole plate 110b only allows for a limited available space. Each of the three lateral most first apertures 125b″ can define a sub-aperture. In some embodiments, the first apertures 125b″ are not connected one another and, therefore, can be regarded as discontinuous. As shown in FIG. 2, the overall perimeter of the three first apertures 125b″ is bounded by the material of the sole plate 110b and has a closed boundary. Thus, in some embodiments, the three first apertures 125b″ can form one group as described elsewhere herein.

In some embodiments, as shown in FIG. 2 and FIG. 1, the one or more first apertures 125a, 125b can define through holes.

Additionally or alternatively, in some embodiments, the one or more first apertures 125a, 125b can extend in a longitudinal direction of the sole plate 110a, 110b and in a transverse direction of the sole plate 110a, 110b. The extension in the longitudinal direction can be larger compared to the extension in the transverse direction. The longitudinal direction can be substantially parallel to and/or the same as the heel to toe axis HT of the sole plate 110a, 110b. The transverse direction can be substantially parallel to and/or the same as the medial to lateral axis ML of the sole plate 110a, 110b.

In some embodiments, the one or more first apertures 125a, 125b can be arranged in the first portion 115a, 115b of the sole plate 110a, 110b. In some embodiments, the sole plate 110a, 110b can comprise one or more second apertures 126a, 126b arranged in the second portion 116a, 116b of the sole plate 110a, 110b.

In some embodiments, as shown in FIG. 2 and FIG. 1, the number of the one or more first apertures 125a, 125b can be different than the number of the one or more second apertures 126a, 126b. In some embodiments, the number of the one or more first apertures 125a, 125b can be greater than the number of the one or more second apertures 126a, 126b.

In some embodiments, the one or more first apertures 125a, 125b and/or the one or more second apertures 126a, 126b can have a length L (as shown in FIG. 2 for one second aperture 126b of the one or more second aperture 126b in the lower left part of the sole plate 110b), such as in a longitudinal direction (corresponding to the heel to toe axis HT) of the sole plate 110a, 110b, of at least 1 cm, at least 2 cm, at least 4 cm, at least 6 cm, at least 7 cm, at least 8 cm, at least 10 cm, at least 12 cm, at least 14 cm, or at least 15 cm. Additionally or alternatively, the one or more first apertures 125a, 125b and/or the one or more second apertures 126a, 126b can have a length L, such as in a longitudinal direction (corresponding to the heel to toe axis HT) of the sole plate 110a, 110b, of at most 25 cm, at most 23 cm, at most 20 cm, at most 18 cm, at most 16 cm, or at most 15 cm.

In some embodiments, the sole plate 110a, 110b can have a maximum thickness of at most 10 mm, at most 8 mm, at most 6 mm, at most 5 mm, at most 4 mm, or at most 3 mm. As described elsewhere herein, the sole plate 110a, 110b can comprise a varying thickness, which can contribute to a tapered shape of the sole plate 110a, 110b. By varying the thickness on the sole plate 110a, 110b, various different effects can be achieved, such as differences in the stiffness, hardness, and/or flexural modulus of the sole plate 110a, 110b in areas of the sole plate 110a, 110b that have different thicknesses.

The thickness of the sole plate 110a, 110b can be measured substantially along a vertical axis when the sole plate 110a, 110b is used according to its ordinary use. In some embodiments, the thickness of the sole plate 110a, 110b in FIG. 2 can be substantially parallel to a line projecting substantially perpendicularly through the image plane.

In some embodiments, the sole plate 110a, 110b can be an integrally formed piece. In some embodiments, the sole plate 110a, 110b can extend from a heel region (similar to the rearfoot portion 113a, 113b) of the sole plate 110a, 110b to a toe region (similar to forefoot portion 111a, 111b) of the sole plate 110a, 110b.

FIG. 2a shows a detailed view of FIG. 1, according to some embodiments. For brevity, only the right shoe 100a and, correspondingly, the right sole plate 110a is shown and described. The description of the right shoe 100a and the right sole plate 110a can be applied to the left shoe 100b and the left sole plate 110b. The embodiment shown in FIG. 2a is similar to those shown in FIGS. 1 and 2. Therefore, the description of the embodiments of FIGS. 1 and 2 can be applied to the description of FIG. 2a, with the differences described herein.

In FIG. 2a, the one or more spikes 127 are shown that are received in the one or more receptacles 127′ as depicted in FIG. 1 and FIG. 2. In some embodiments, the one or more spikes 127 can be integrally formed with the sole plate 110a, 110b. In such embodiments, the one or more receptacles 127′ can be omitted.

In some embodiments, the one or more spikes 127 can have a cone shape (for example, as shown in FIG. 2a). However, the one or more spikes 127 are not limited to a cone shape or other geometric shapes. For example, the one or more spikes 127 can be have various shapes and configurations depending on the type of running surface and/or the specific needs of the athlete.

More specifically, the one or more spikes can have one or more of the following shapes and/or configurations.

In some embodiments, the one or more spikes 127 can have a pyramid shape. In such embodiments, the one or more spikes 127 can provide versatility for the athlete. For example, the one or more spikes 127 having a pyramid shape can provide good traction on a variety of surfaces, including track and grass.

In some embodiments, the one or more spikes 127 can be needle spikes, which can be thin and needle-like, and having minimal surface area as compared to other shapes of the one or more spikes 127. The one or more spikes 127 can be used on softer surfaces like grass or well-maintained tracks.

In some embodiments, the one or more spikes 127 can have a Christmas tree shape. Named for their resemblance to Christmas trees, the one or more spikes 127 that have a Christmas tree shape can have a pyramid shape with multiple points. The one or more spikes 127 having a Christmas tree shape can offer a good balance of traction and durability and can be suitable for various running surfaces.

In some embodiments, the one or more spikes 127 can be bladed, such that the one or more spikes 127 can have a flat, blade-like shape, thereby providing more surface area than spikes having a pyramid shape. The one or more spikes 127 having a bladed shape can be useful on synthetic tracks and can offer good grip on such tracks.

In some embodiments, the one or more spikes 127 can be wrench spikes, which can have a unique, twisted shape resembling a wrench. The one or more spikes 127 having a wrench design can provide for maximum traction on soft or muddy surfaces, making them suitable for cross-country running.

In some embodiments, the one or more spikes 127 can be hexagonal spikes, which have a six-sided shape that can offer a combination of grip and stability. The one or more spikes 127 having a hexagonal shape can be used in sprinting events on tracks.

In some embodiments, the one or more spikes 127 can be compression spikes, which can have a flat, wide shape and can compress the track slightly upon impact, providing better energy return. The one or more spikes 127 that are compression spikes can be used in sprinting events.

As described above, the shape of the one or more spikes 127 can depend on factors such as the type of running, the running surface, and personal preference.

FIG. 3 shows the first sole plate 110a and the second sole plate 110b, each respectively for an article of footwear, such as for a sports shoe 100a, 100b, during manufacturing thereof, according some embodiments.

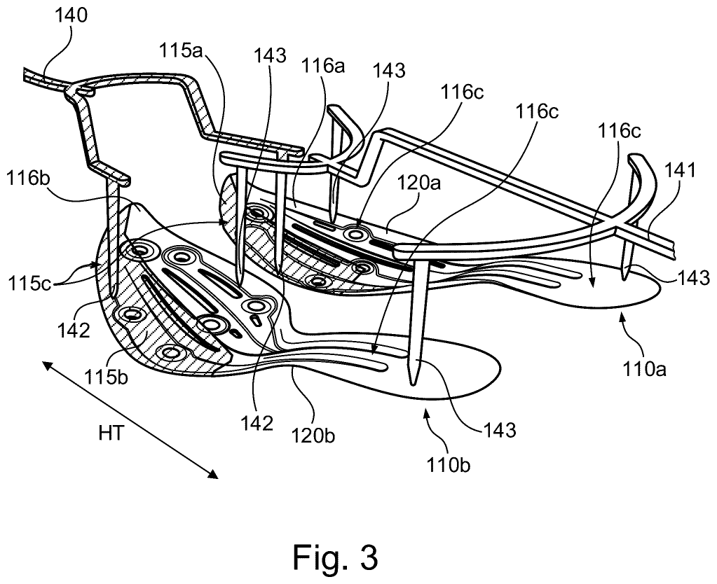

In some embodiments, FIG. 3 can show the first sole plate 110a and the second sole plate 110b during the method 200 described with reference to FIG. 4. As can be seen, injecting the second material 116c (for example, as shown in step 230 of FIG. 4) can comprise using more injection nozzles 143 as compared to the injection nozzles 142 used for injecting the first material 115c (for example, as shown in step 220 of FIG. 4). For example, four injection nozzles 143 can be used for injecting the second material 116c, and two injection nozzles 142 can be used for injecting the first material 115c. In some embodiments, a feed line 140 can provide the first material 115c to the injection nozzles 142, and a feed line 141 can provide the second material 116c to the injection nozzles 143. Various different numbers of injection nozzles 142, 143 and/or various different number of feed lines 140, 141 can be implemented.

Injecting the second material 116c using more of the injection nozzles 143 as compared to injecting the first material 115c using the injection nozzles 142 can provide a range of benefits. For example, using more nozzles to inject the second material 116c can allow the second material 116c to be distributed over a wider area or a larger volume than using fewer nozzles. In some embodiments, the first material 115c and the second material 116c can be mixed. In such embodiments, using more nozzles for the second material 116c can improve the quality of the mix and the uniform dispersion of the materials 115c, 116c. Further, additional injection nozzles 143 can provide better control over the amount and rate of the injection of the second material 116c. In addition, more injection nozzles 143 as compared to injection nozzles 142 can increase the rate of injection of the second material 116c as compared to the rate of injection of the first material 115c, thereby reducing the time required for the injection process. Furthermore, material properties like viscosity or reaction rate of the second material 116c can make it beneficial to use more injection nozzles 143 for smooth and efficient processing.

FIG. 4 shows a flow chart of a method 200 for manufacturing the one or more sole plates 110a, 110b, according to some embodiments.

The method 200 can comprise: providing 210 a mold; injecting 220 the first material 115c (as shown in FIG. 3) into the mold; injecting 230 the second material 116c (as shown in FIG. 3) into the mold. In some embodiments, injecting 220 the first material 115c and injecting 230 the second material 116c can take place at least partially at the same time.

As described elsewhere herein, by injecting 220 the first material 115c and injecting 230 the second material 116c at least partially at the same time, the method 200 of manufacturing can be executed quicker as compared to methods in which the materials are not injected at least partially at the same time, thereby reducing the overall manufacturing time. This can increase productivity, reduce costs, result in a more homogenous mix or a better controlled reaction between the first material 115c and the second material 116c, and improve product quality. For example, and as described elsewhere herein, by injecting 220 the first material 115c and injecting 230 the second material 116c at least partially at the same time, a seamless transition from one material to the other material (e.g., from the first material 115c to the second material 116c and/or from the second material 116c to the first material 115c) can be achieved. A seamless transition between materials can provide a sole plate 110a, 110b without any weak points and/or junctions.

Furthermore, a seamless transition between materials can avoid or eliminate potential issues such as premature hardening or degradation of one material 115c, 116c before the other material 115c, 116c.

In some embodiments, the first material 115c can be different than the second material 116c. For example, the second material 116c can have a greater stiffness as compared to the first material 115c.

In some embodiments, as an optional step (as indicated by the dashed box in FIG. 4), the method 200 comprises forming 240 the first sole plate 110a and the second sole plate 110b at the same time. The first sole plate 110a can be the sole plate 110a for the right shoe 100a and the second sole plate 110b can be the sole plate 110b for the left shoe 100b. In some embodiments, forming 240 the first sole plate 110a and the second sole plate 110b at the same time can provide consistency between the two sole plates 110a, 110b, as they can be made under substantially the same conditions at the same time. The consistency between the two sole plates 110a, 110b can contribute to the overall quality and uniformity of the sole plates 110a, 110b, such as when the two sole plates 110a, 110b are used for a pair of shoes comprising the right shoe 100a and the left shoe 100b. Moreover, forming 240 the first sole plate 110a and the second sole plate 110b at the same time can simplify the process flow by eliminating the need to complete one part before starting with another, thus reducing production steps and possible machine downtime. Furthermore, utilization of the production capacity can be better when producing two sole plates 110a, 110b simultaneously (as opposed to sequentially or non-simultaneously), thereby leading to higher profitability.

In some embodiments, the first sole plate 110a can comprise: the first portion 115a arranged on the medial side 121a of the first sole plate 110a; and the second portion 116a arranged on the lateral side 120a of the first sole plate 110a. In some embodiments, the second sole plate 110b can comprise: the first portion 115b arranged on the lateral side 120b of the second sole plate 110b; and the second portion 116b arranged on the medial side 121b of the second sole plate 110b. In some embodiments, injecting 220 the first material 115c can comprise injecting 220 the first material 115c in the first portion 115a of the first sole plate 110a and in the first portion 115b of the second sole plate 110b. In some embodiments, injecting 230 the second material 116c can comprise injecting 230 the second material 116c in the second portion 116a of the first sole plate 110a and in the second portion 116b of the second sole plate 110b.

In some embodiments, the first sole plate 110a and the second sole plate 110b can form an asymmetric pair of sole plates 110a, 110b. The asymmetric design can provide possibilities for fine-tuning and individual customizations that cannot be achieved with symmetrical designs.

In some embodiments, performing the method 200 as described herein can result in the manufacturing of a sole plate 110a, 110b for an article of footwear, such as for a sports shoe 100a, 100b, such as a running shoe.

As described elsewhere herein, in some embodiments, an apparatus for manufacturing one or more sole plates 110a, 110b for one or more articles of footwear, such as for a sports shoe 100a, 100b such as a running shoe, can be provided, wherein the apparatus can perform the method 200 according to any one of the embodiments described in here.

As described elsewhere herein, in some embodiments, an article of footwear (for example, as shown in FIG. 1), such as a sports shoe 100a, 100b such as a running shoe can be provided, wherein the article of footwear can comprise a sole plate 110a, 110b as described in any one of the embodiments described herein; and an upper 130a, 130b. In some embodiments, the sole plate 110a, 110b can be attached to the upper 130a, 130b.

As described elsewhere herein, in some embodiments, a pair of shoes 100a, 100b (for example, as shown in FIG. 1) can comprise a right shoe 100a and a left shoe 100b, wherein the right shoe 100a can comprise a first sole plate 110a as described in any one of the embodiments herein. In some embodiments, the left shoe 100b can comprise a second sole plate 110b as described in any one of the embodiments described herein.

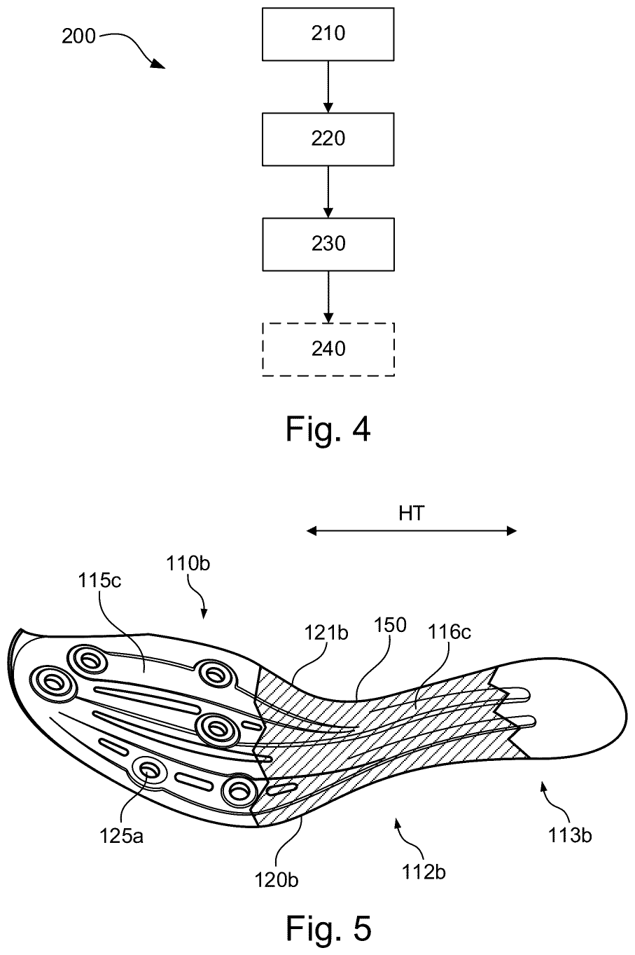

FIG. 5 shows a second sole plate 110b for an article of footwear, in particular a sports shoe 100a, 100b, according to some embodiments. For purposes of brevity, only the second sole plate 110b is shown. The description of the second sole plate 110b can be applied to the first sole plate 110a, in some embodiments. Furthermore, features of the embodiment of FIG. 5 not described as being different as compared to features of other embodiments of the present disclosure can be similar to the features of the other embodiments of the present disclosure.

In some embodiments, the sole plate 110b shown in FIG. 5 can comprise a first portion that comprises a first material 115c (the first material 115c is also shown, for example, in FIG. 3). In some embodiments, the sole plate 110b can comprise a second portion that comprises a second material 116c (the second material 116c is also shown, for example, in FIG. 3). The second material 116c can have a greater stiffness than the first material 115c. In some embodiments, the second sole plate 110b can be a left sole plate 110b for a left shoe 100a. In some embodiments, the sole plate 110b can comprise one or more first apertures 125a (for example, in the forefoot part of FIG. 5, on the left-hand side of FIG. 5).

In some embodiments, the second material 116c is can be provided in a shank 150 of the sole plate 110b.

In some embodiments, the shank 150 can be a supportive structure located between the insole (for example, an inner sole of the shoe) and the outsole (for example, a bottom of the shoe that makes contact with the ground). The shank 150 can be a thin, flat piece of material (for example, metal, plastic, or fiberglass), that runs lengthwise from the heel portion to the forefoot portion.

In some embodiments, the shank 150 can provide stability and support to the arch of the foot. For example, the shank 150 can help prevent the shoe from collapsing under the weight of the body and can provide structure to the midfoot portion 112b of the sole plate 110b. Additionally or alternatively, the shank 150 can provide protection against sharp objects on the ground from contacting the foot of the wearer.

In some embodiments, the sole plate 110b can be stiffer in the area that corresponds to the shank 150 as compared to other areas of the sole plate 110b. Reinforcement of the shank 150 (for example, making the shank 150 stiffer), can be achieved by positioning the injection nozzle 143 (as shown in FIG. 3) with the second material 116c (for example, a stiffer material) at the shank 150 of the sole plate 110b and positioning the injection nozzle 142 with the first material 115c (for example, a softer material) at the rest of the sole plate 110b during the injection step.

The shank 150 can vary in flexibility and rigidity, depending on the type of shoe and its intended use. For example, a more flexible shank 150 can be desirable to allow for a more natural foot movement. In some embodiments, a rigid shank 150 can provide extra support (for example, for traversing uneven terrain).

In some embodiments, it is possible that the sole plate 110a, 110b described herein can be additionally or alternative used for any devices, components, and/or equipment used in any kind of athletic activities. For example, the sole plate 110a, 110b is not necessarily limited to the examples described herein of an article of footwear. In some embodiments, the concept of the sole plate 110a, 110b can transferred to any kind of athletic activity in which a more tailored and/or targeted functionality and support for an athlete needs to be provided.

The sole plate 110a, 110b described herein can be advantageous when applied to an article of footwear, such as a sports shoe 100a, 100b used during an athletic activity, such as during running and, more specifically, such as during running on an athletics track (during, for example, track and field events). Another example of an athletic activity during which the advantages of the sole plate 110a, 110b can be useful is high-jump or any other suitable sports discipline in track and field sport events.

In any of the embodiments of sole plate 110a, 110b for an article of footwear, such as the sports shoe 100a, 100b, as described herein, the first material 115c can comprise one or more of the following materials: polyamide (PA), polyurethane (PU), or thermoplastic polyurethane (TPU).

In any of the embodiments of the sole plate 110a, 110b for an article of footwear, such as the sports shoe 100a, 100b, as described herein, the second material 116c can comprise one or more of the following materials: polyamide (PA), fiber-reinforced PA, or carbon fiber-reinforced PA, wherein the carbon content by weight can be at least 1%, at least 2%, at least 4%, or at least 6%.

It is noted that many material combinations can be possible. This can be dependent on the specific requirements on performance, and/or stiffness, and/or hardness, and/or flexural modulus. Both materials (for example, the first material 115c and the second material 116c), can be injected at least partially at the same time into a mold. Thus, both materials can be liquid inside the mold. As a result, the first material 115c and the second material 116c can be mixed and/or combined while in the liquid state in the mold, which can limit or prevent debonding issues.

The materials used for the first material 115c and/or the second material 116c can have a wide range of characteristics and can be used for many applications due to their varied degrees of hardness, density, flexural modulus, elasticity, cold and heat resistance, durability, and resilience. Moreover, the first material 115c and the second material 116c can have high wear and abrasion resistance, which makes them suitable for the sole plate 110a, 110b, as the sole plate 110a, 110b can require a long lifespan. PA, fiber-reinforced PA, PU, and TPU, each can provide good resistance to oil, grease, and a variety of chemicals, and can also provide good weather and aging resistance. In some embodiments, the use of fiber-reinforced PA, can provide better performance and durability of the sole plate 110a, 110b as compared to the other materials because the fibers can enhance the strength and stiffness of the material. Moreover, PA, PU, and TPU are thermoplastics and can be easily molded into intricate shapes and designs, enabling the creation of complex and precise components. In addition, as thermoplastics, these materials can often be melted down and reused, contributing to waste reduction and sustainability efforts.

Any one of the embodiments described herein and/or examples can be combined with any other embodiment as described herein. Additionally or alternatively, details of the embodiments and/or examples can also be omitted, as will be understood by the skilled person.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A sole plate for an article of footwear, comprising:
a first portion comprising a first material; and
a second portion comprising a second material;
wherein the second material has a greater stiffness than the first material; and
wherein, when the sole plate is for a right shoe, the first portion is arranged on a medial side of the sole plate and the second portion is arranged on a lateral side of the sole plate, or
wherein, when the sole plate is for a left shoe, the first portion is arranged is arranged on a lateral side of the sole plate and the second portion is arranged on a medial side of the sole plate,
wherein the sole plate comprises one or more first apertures.

2. The sole plate of the claim 1, wherein the second material has a stiffness compared to the first material of at least 1.1 times greater than the stiffness of the first material.

3. The sole plate of claim 1, wherein the second material has a greater hardness than the first material.

4. The sole plate of the claim 3, wherein the first material has a shore D hardness of at most 70 shore D, or wherein the second material has a shore D hardness of at least 65 shore D.

5. The sole plate of claim 1, wherein the second material has a greater flexural modulus compared to the first material.

6. The sole plate of claim 1, wherein the one or more first apertures define through holes.

7. The sole plate of claim 1, wherein the one or more first apertures extend in a longitudinal direction of the sole plate and in a transverse direction of the sole plate,
wherein the extension in the longitudinal direction is larger compared to the extension in the transverse direction.

8. The sole plate of claim 1, wherein the one or more first apertures are arranged in the first portion of the sole plate.

9. The sole plate of claim 1, wherein the sole plate comprises one or more second apertures arranged in the second portion of the sole plate.

10. The sole plate of claim 9, wherein a number of the one or more first apertures is greater than a number of the one or more second apertures.

11. The sole plate of claim 1, wherein one or more spikes are arranged on a forefoot portion of the sole plate,
wherein the sole plate comprises one or more receptacles, wherein the one or more receptacles are arranged on the forefoot portion of the sole plate, and wherein the one or more receptacles are configured to receive the one or more spikes.

12. The sole plate of claim 9, wherein the one or more first apertures and/or the one or more second apertures have a length (L) in a longitudinal direction of the sole plate of at least 1 cm,
or wherein the one or more first apertures or the one or more second apertures have a length (L) in a longitudinal direction of the sole plate of at most 25 cm.

13. The sole plate of claim 1, wherein the sole plate comprises an integrally formed piece extending from a heel region of the sole plate to a toe region of the sole plate.

14. A method for manufacturing one or more sole plates for one or more articles of footwear, the method comprising:
providing a mold;
injecting a first material into the mold; and
injecting a second material into the mold;
wherein injecting the first material and injecting the second material takes place at least partially at the same time.

15. The method of the claim 14, wherein the first material is different than the second material.

16. The method of claim 14, wherein the second material has a greater stiffness compared to the first material.

17. The method of claim 14, comprising forming a first sole plate and a second sole plate at the same time.

18. The method of claim 17, wherein the first sole plate comprises a first portion arranged on a medial side of the first sole plate and a second portion arranged on a lateral side of the first sole plate;
wherein the second sole plate comprises a first portion arranged on a lateral side of the second sole plate and a second portion arranged on a medial side of the second sole plate;
wherein injecting the first material comprises injecting the first material in the first portion of the first sole plate and in the first portion of the second sole plate; and
wherein injecting the second material comprises injecting the second material in the second portion of the first sole plate and in the second portion of the second sole plate.

19. The method of claim 17, wherein the first sole plate and the second sole plate form an asymmetric pair of sole plates.

20. The sole plate of claim 1, wherein the first material comprises one or more of the following: polyamide, PA, polyurethane, PU, thermoplastic polyurethane, TPU,
or wherein the second material comprises one or more of the following: polyamide (PA), fiber-reinforced PA, or carbon fiber-reinforced PA, wherein a carbon content by weight of the carbon fiber-reinforced PA is at least 1%.
